(19) United States
(12) Patent Application Publication
(10) Pub. No.: US 2026/0136188 A1
(43) Pub. Date: May 14, 2026

(54) USER TAGS BEACON-BASED MOBILITY MANAGEMENT FOR COMMUNICATION SERVICES VIA I/O USER DEVICES PERFORMING USER TERMINAL EMULATION AS A CLOUD COMPUTING SERVICE

(71) Applicant: Telefonaktiebolaget LM Ericsson (publ), Stockholm (SE)

(72) Inventors: Peter ÖKVIST, LULEÅ (SE); Patrik SALMELA, ESPOO (FI); Niklas LINDSKOG, LUND (SE); Tommy ARNGREN, SÖDRA SUNDERBYN (SE); Hans HANNU, LULEÅ (SE)

(73) Assignee: Telefonaktiebolaget LM Ericsson (publ), Stockholm (SE)

(21) Appl. No.: 19/118,093

(22) PCT Filed: Oct. 4, 2022
(86) PCT No.: PCT/EP2022/077570

§ 371 Date: Apr. 3, 2025

(51) Int. Cl. H04W 12/069; H04B 17/318; H04L 67/08; H04W 4/80

(52) U.S. Cl. CPC H04W 12/069; H04L 67/08; H04W 4/80; H04B 17/318

(57) ABSTRACT

A mobility manager manages mobility of a communication service for a user through I/O user devices. The mobility manager receives from a plurality of I/O user devices, a beacon signal measurement and session related information. The beacon signal measurement indicates a signal strength measurement by the I/O user device of a beacon signal from a user tag transportable by the user. The mobility manager initiates mobility switching of an I/O traffic stream associated with the session related information from being routed between a user terminal emulation application hosted by a user terminal emulation server and a first I/O user device to being routed between the user terminal emulation application and a second I/O user device, responsive to determining a mobility switching rule is satisfied based on comparison of the beacon signal measurements by the first I/O user device and the second I/O user device.

### TECHNICAL FIELD

The present disclosure relates to providing communication services through user terminals of a wireless communications system.

### BACKGROUND

The market for user terminals is driven by the quest to provide users with increasingly advanced communication and other operational features within the constraints of a portable handheld form factor. The development requirements for user terminal are increasingly complex as designers seek to integrate a greater variety of user interfaces and advanced operational features within the portable handheld form factor. Advancements in operational features have required more highly integrated and faster processing circuits with greater circuit densities, which becomes more difficult under constraints on costs and power consumption.

This all-inclusive feature-rich approach for user terminal development does not satisfy all of the myriad of differing desires held by consumers seeking solutions for the rapidly expanding variety of communication services. Moreover, the always-connected expectations of today's society obligate users to vigilantly keep their user terminals within reach or risk being unable to timely receive or initiate communication services.

### SUMMARY

Some embodiments disclosed herein are directed to a user tag which is transportable by a user and includes circuitry which is configured to perform an authentication process with an authenticator via communications through an input and/or output (I/O) user device to obtain session related information. The circuitry is further configured to transmit a beacon signal containing the session related information to I/O user devices proximately located to the user tag.

Some other related embodiments disclosed herein are directed to an I/O user device that includes circuitry configured to receive a beacon signal from a user tag. The beacon signal contains session related information. The circuitry is further configured to measure signal strength of the beacon signal to generate a beacon signal measurement, and to send the beacon signal measurement and the session related information for use by a mobility manager for mobility management of a communication service for the user that can be provided by a user terminal emulation server through one or more I/O user devices.

Some other related embodiments disclosed herein are directed to a mobility manager for managing mobility of a communication service for a user through I/O user devices. The mobility manager includes circuitry configured to receive from a plurality of I/O user devices, a beacon signal measurement and session related information, the beacon signal measurement indicating a signal strength measurement by the I/O user device of a beacon signal from a user tag transportable by the user. The circuitry is further configured to initiate mobility switching of an I/O traffic stream associated with the session related information from being routed between a user terminal emulation application hosted by a user terminal emulation server and a first I/O user device to being routed between the user terminal emulation application and a second I/O user device, responsive to determining a mobility switching rule is satisfied based on comparison of the beacon signal measurements by the first I/O user device and the second I/O user device.

Some other related embodiments disclosed herein are directed to an authenticator that includes circuitry configured to establish a key through an authentication process with a user tag via a first I/O user device. The authenticator authenticates a beacon signal from the first I/O user device based on the key. The beacon signal is accompanied by a beacon signal measurement that indicates a signal strength measurement by the first I/O user device of the beacon signal from a user tag transportable by the user. The beacon signal is secured using the key. The circuitry is further configured to respond to authentication of the beacon signal, by sending the beacon signal measurement to a mobility manager managing mobility of a communication service for a user through I/O user devices.

Some potential advantages of these and related embodiments include that a user can receive and initiate communication services without the necessity of a traditional all-inclusive feature-rich user terminal. The centralized server-based approach emulates a user terminal using one or more networked I/O user devices that are proximately located to a user tag transported by the user, and where the I/O user devices individually or combinable have user interface (UI) capabilities to provide an I/O user interface for the user to interface with a user terminal emulation application of the server to perform a communication service. Various embodiments disclosed herein can provide and improve upon managing mobility for communication services that are presently being provided or are available to be provided by the centralized server-based approach for emulating a user terminal using I/O user device(s). The mobility management decisions can track in more real-time proximity and radio conditions indicated by the beacon signal measurements reported by the I/O user devices, and can be performed while maintaining secure control plane termination in the user tag and secure data plane termination in the I/O user devices.

Other user tags, I/O user devices, mobility managers, and authenticators according to embodiments of the inventive subject matter will be or become apparent to one with skill in the art upon review of the following drawings and detailed description. It is intended that all such additional user tags, I/O user devices, mobility managers, and authenticators be included within this description, be within the scope of the present inventive subject matter, and be protected by the accompanying claims. Moreover, it is intended that all embodiments disclosed herein can be implemented individually or combined in any way and/or combination

### BRIEF DESCRIPTION OF THE DRAWINGS

Aspects of the present disclosure are illustrated by way of example and are not limited by the accompanying drawings. In the drawings:

FIG. 1 illustrates a system with a user terminal emulation server that operationally integrates sets of I/O user devices that are proximately located to users to logically form virtualized user terminals providing communication services in accordance with some embodiments of the present disclosure;

FIG. 2 illustrates a block diagram illustrating the user terminal emulation server communicating with various elements of a cellular system to provide communication services in accordance with some embodiments of the present disclosure;

FIG. 3 illustrates a block diagram illustrating the user terminal emulation server communicating in a different manner with various elements of a cellular system to provide communication services in accordance with some other embodiments of the present disclosure;

FIGS. 4 and 5 illustrate combined flowcharts of operations and related data flows between a user tag, I/O user devices, an Extensible Authentication Protocol (EAP) authenticator, and a user terminal emulation server which may include an EAP server in accordance with some embodiments of the present disclosure;

FIG. 6 illustrates a combined flowchart of operations and related data flows between a user tag, I/O user devices, a 3GPP key agreement function system, and a user terminal emulation server in accordance with some embodiments of the present disclosure;

FIG. 7 illustrates a block diagram of hardware circuit components of an I/O user device which are configured to operate in accordance with some embodiments;

FIG. 8 illustrates a block diagram of hardware circuit components of a user terminal emulation server that are configured to operate in accordance with some embodiments of the present disclosure;

FIG. 9 illustrates a block diagram of hardware circuit components of an EAP authenticator or AKMA server that are configured to operate in accordance with some embodiments of the present disclosure;

FIG. 10 illustrates a block diagram of hardware circuit components of a user tag that are configured to operate in accordance with some embodiments of the present disclosure;

FIG. 11 illustrates a block diagram of hardware circuit components of a mobility manager that are configured to operate in accordance with some embodiments of the present disclosure;

FIG. 12 illustrates a mobility scenario and some related mobility management operations that can be performed by a mobility manager in accordance with some embodiments of the present disclosure.

FIGS. 13A and 13B illustrate operations for mobility management of an active session in accordance with some embodiments of the present disclosure;

FIG. 14 illustrates operations for mobility management during idle in accordance with some embodiments of the present disclosure;

FIG. 15 illustrates a flowchart of operations that can be performed by a user tag in accordance with some embodiments of the present disclosure;

FIG. 16 illustrates a flowchart of operations that can be performed by an I/O user device in accordance with some embodiments of the present disclosure;

FIG. 17 illustrates a flowchart of operations that can be performed by a mobility manager in accordance with some embodiments of the present disclosure; and

FIG. 18 illustrates a flowchart of operations that can be performed by an authenticator in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

Various embodiments disclosed herein are directed to improvements in managing mobility for communication services provided by a centralized server-based approach for emulating a user terminal using one or more networked input and/or output (I/O) user devices. The I/O user devices are proximately located to a mobile user who is transporting a user tag. The I/O user devices individually or through a combination thereof have user interface (UI) capabilities which are needed to provide an I/O user interface for the user to interface with a user terminal emulation application of the server to provide a communication service to the user.

Some potential advantages of these embodiments include that a user can obtain a communication service without the necessity of a traditional all-inclusive feature-rich user terminal, i.e., a conventional smartphone, mobile phone, tablet computer, etc. A user terminal emulation server can utilize the available UI capability of one or more I/O user devices that are proximately located to a user to provide user terminal functionality for a communication service. The server-based approach can provide low-cost adaptable communication services to users. Embodiments disclosed herein can enable more operationally effective setup and handover of communication services when a user is moving into and out of the proximity of I/O user devices.

Dynamic allocation of I/O user device capabilities whenever and wherever the I/O user devices are in the proximity of a user enables efficient and flexible use of existing hardware, such as televisions, conference phones, laptops, surveillance cameras, connected household appliances, connected cars, etc., that is capable of providing necessary UI functionality to user during a communication service. The user thereby has reduced or no need to carry an expensive and all-inclusive user terminal, e.g., smart phone, that includes all necessary UI capabilities, display device, keyboard, speakers, etc. The user may instead carry a hardware device which operates to identify the user, referred to as a “UserTag” or “user tag”, over a wireless or wired (e.g., smartcard reader) communication interface, such as a near field communication (NFC) interface, to one or more of the I/O user devices. Various embodiments disclosed herein may disrupt the traditional handset-centric mobile communication industry as the features and capabilities of what forms a user terminal are not constrained to the domain of mobile phone manufacturers. A user terminal emulation server can operate to provide a user terminal, which can also be referred to as a SoftUE or a user terminal emulation application that is run by the user terminal emulation server.

The mobility management decisions for switching streams between I/O user devices can be made to track in more real-time proximity and radio conditions indicated by the beacon signal measurements reported by the I/O user devices, and be performed while maintaining secure control plane termination in the user tag and secure data plane termination in the I/O user devices

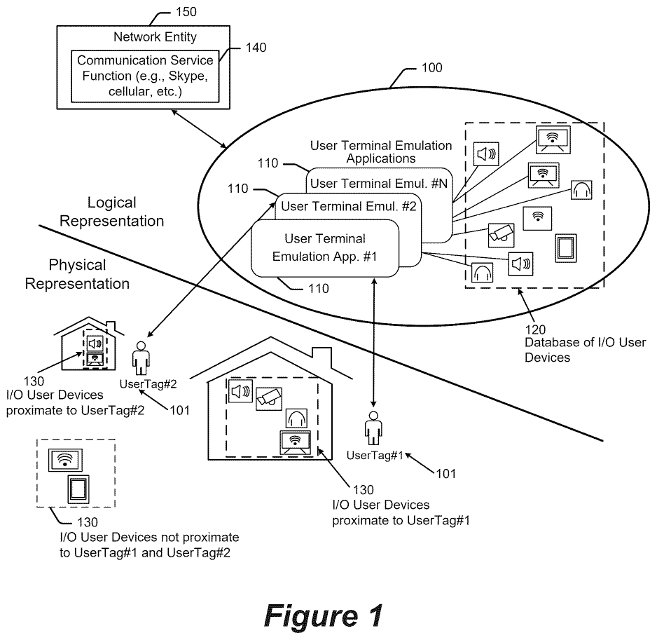

FIG. 1 illustrates a system with a user terminal emulation server 100 that can use one or more I/O user devices 130 that is/are proximately located to users to logically emulate a user terminal providing a communication service in accordance with some embodiments of the present disclosure. The user terminal emulation server 100 may operationally integrate the UI capabilities of a set of the I/O user devices 130 to logically emulate a user terminal providing communication services in accordance with some embodiments of the present disclosure.

Referring to FIG. 1, the user terminal emulation server 100 may be a cloud resource that is networked and remote from the I/O user devices 130, or may be more proximately located on a shared network with the I/O user devices 130. The user terminal emulation server 100 is configured to communicate with the I/O user device(s) 130 proximately located to a user who can use the UI capabilities of the proximate I/O user device(s) 130 during a communication service.

Users may carry a hardware tag, a.k.a. “UserTag” or “user tag”, which is capable of transmitting a unique user identifier through a communications interface, such as a near-field communications interface (e.g., Bluetooth, BLE, NFC, RFID, etc., or combinations thereof), for receipt by one or more of the I/O user devices 130 which are proximately located to the user. One type of UserTag can be a low-complexity stand-alone electronic device having limited operational capability for transmitting an identifier through a near-field communications interface and performing authentication operations such as described herein. Another type of UserTag can have more operational capability (e.g., processing and memory hardware resources), such as a smartphone or smartwatch having cellular connectivity that transmits a cellular identity (e.g., from a SIM card) or an application identity through a cellular interface or a near-field communications interface and is configured to perform authentication operations such as described herein. A UserTag may be a device that does not require human interaction in order to interact with an I/O user device, and may lack a user interface. A UserTag may be configured to interact with one or more types of Internet of things (IoT) devices, such as a camera, sensor, or other electronic device having Internet or other wireless connectivity.

The user identifier may alternatively or additionally be operationally determined by biometrics operations performed by, e.g., one or more of the I/O user devices 130. The biometrics operations may include, without limitation, one or more of voice recognition, image/face recognition, eye recognition, fingerprint recognition, or a combination thereof. The user identity may be determined based on credential provided by the user when, e.g., logging into an application or account. The user identity may be provided by a cell phone using information from the subscription SIM and proximity of the cell phone to one or more of the I/O user devices 130 can be determined using the phone's NFC capability.

A user identifier, a UserTag identifier, and a user terminal emulation application 110 can be logically associated with each other in a database 120 during a user registration process or as part of another setup process. For example, during a user registration process a user may obtain an account login identifier (serving as the user identifier) that is registered in the database 120 as being associated with a UserTag identifier for a physical UserTag that has been provided to (e.g., purchased by) the user and being associated with a user terminal application 110 that emulates a user terminal having defined capabilities (e.g., a cell phone providing cellular and over-the-type voice-over-IP communication services).

The user terminal emulation server 100 may maintain in the database 120 network addresses of I/O user devices 130 and UI capabilities of the I/O user devices 130. Although the database 120 is illustrated as residing in the example server 100, in some other embodiments information described below as residing in the database 120 may alternatively or additionally be stored within the IODH 212 and/or the user terminal emulation applications 110. The capabilities of the I/O user devices 130 may be logically arranged in the database 120 based on the type of UI capability provided, e.g., display device, microphone, speaker, keyboard, and may be further arranged based on a quality of service provided by the UI capability.

The user terminal emulation server 100 may register a network address of one of the user terminal emulation applications 110 and an identity of a user with a network entity 150 providing communication services. The network entity 150 provides a communication service function 140 which may, for example, correspond to an over-the-top Voice Over Internet Protocol (VoIP) service, Netflix service, Facebook service, Microsoft Teams meeting service, Internet browser service, a cellular communication service, etc. The user terminal emulation application 110 is executed by the user terminal emulation server 100. A user terminal emulation application 110 may run one or more applications that are normally run by a smart phone, such as a Netflix application, Facebook application, Microsoft Teams application, Internet browser application, etc.

As illustrated in FIG. 1, a different instantiation of the user terminal emulation application 110 may be hosted by the server 100 for each user who is to be provided communication services (i.e., illustrated user terminal emulation applications #1-#N corresponding to users 1-N). The user terminal emulation application 110 may perform registration of the user with the network entity 150 and setup of a communication service with a user responsive to communication requests.

When the communication service function 140 of the network entity 150 is a VoIP service, the operation to register the network address of the user terminal emulation application and the identity of the user with the network entity can include registering the network address of the user terminal emulation application 110 and the identity of the user with a network server of a VoIP communication service provider.

When the communication service function 140 of the network entity 150 is a cellular communication service, the operation to register the network address of the user terminal emulation application and the identity of the user with the network entity can include registering the network address of the user terminal emulation application 110 and the identity of the user with a Home Subscriber Server (HSS) or other network node of a core network operated by a cellular communication service provider.

The user terminal emulation server 100 may receive the registration messages from the I/O user devices using the Session Initiation Protocol (SIP)/Session Description Protocol (SDP), where each of the registration messages identifies the network address and the UI capability of one of the I/O user devices. The communication request may be received from the network entity 150 using the SIP/SDP, and the operation to provide communication sessions between the user terminal emulation application 110 and each of the I/O user devices in the set, and between the user terminal emulation application 110 and the requesting user terminal may be performing using the SIP/SDP.

A registration message from an I/O user device can include, for example, an IP address and port number, MAC address, fully qualified domain name (FQDN), and/or another network address, and can further include information identifying the UI capability of the I/O user device. The I/O user device may respond to becoming powered-on by communicating the registration message to the user terminal emulation server 100.

The user terminal emulation server 100 receives a communication request from the network entity 150 for establishing a communication service between the user and a requesting user terminal, e.g., a cellular phone, computer with Microsoft Teams application, etc. Responsive to the communication request, the user terminal emulation server 100 identifies one or more of the I/O user devices 130, which may be registered in the database, that are proximately located to a location of the user and are determined, based on the UI capabilities identified by the database 120 for the set of I/O user devices and based on content of the communication request, to satisfy a capability rule for being individually usable or combinable to provide an I/O user interface for the user to interface with the user terminal emulation application 110 to provide the communication service. Although various operations are described above and elsewhere as being performed by the user terminal emulation server 100, it is to be understood that these and other operations are performed by the user terminal emulation server 100 executing one or more of the user terminal emulation applications 110 instantiated for a user.

The user terminal emulation server 100 provides one or more communication sessions between the user terminal emulation application 110 and the one or more I/O user devices 130 and between the user terminal emulation application 110 and the requesting user terminal via the network entity 150. The communication request that is received by the user terminal emulation application 110 may contain an indication of a minimum UI capability that must be provided to the user during the communication service, such as: speaker only; combination of speaker and microphone; display only; combination of display device, speaker, and microphone; etc. A UI capability rule which can be used by the server 100 to determine whether a communication service can be provided and by which set of I/O user devices, may thereby be defined based on the minimum UI capability that is indicated by the communication request.

The user terminal emulation server 100 then routes communication traffic between at least one of the I/O user devices in the set and the requesting user terminal via the network entity 150. In some embodiments, for example, for each data type that is received as communication traffic from the requesting user terminal, the user terminal emulation server 100 selects one of the I/O user devices from among the set of I/O user devices based on matching characteristics of the data type to the UI capabilities identified by the database 120 for the one of the I/O user devices, and then routes the data of the data type toward the network address of the selected one of the I/O user devices.

As will be explained in further detail below, the server 100 may also combine data streams that are received from the I/O user devices in the set, and route the combined data streams towards the requesting user terminal, e.g., via the network entity 150.

The user terminal emulation server 100 (e.g., the application 110 or an I/O user device handler described below) may be responsible for tracking which I/O user devices are proximately located to a present location of the user. The server 100 can receive presence reports from individual ones of the I/O user devices containing their network address and an identifier of a user tag which is determined by the I/O user device to be proximately located thereto. For example, an I/O user device may read a user tag through a NFC communication interface and/or may perform other operations to detect presence of a user and to identify a user tag transported by the user. Responsive to the presence reports, the server 100 updates the database 120 to indicate which user tag identifiers are proximately located to which of the I/O user devices.

With further reference to the example system of FIG. 1, a set of I/O user devices 130 has been determined by the instantiated user terminal emulation application #1 to be proximately located to a location of a first user carrying UserTag #1, and to further have UI capabilities that are combinable to satisfy the UI capability rule for providing a combined I/O user interface for the first user to use during a requested communication service. Application #1 responsively uses that set of I/O user devices 130 to provide a combined I/O user interface for use by the first user during a communication service via network entity 150 between the first user and another user terminal.

Similarly, another set of I/O user devices 130 has been determined by the instantiated user terminal emulation application #2 to be proximately located to a location of a second user carrying UserTag #2, and to further have UI capabilities that are combinable to satisfy the UI capability rule for providing a combined I/O user interface for the second user to use during a requested communication service. Application #2 responsively uses that set of I/O user devices 130 to provide a combined I/O user interface for use by the second user during a communication service via network entity 150 between the second user and yet another user terminal.

FIG. 1 also illustrates that another set of I/O user devices 130 is not proximately located to either UserTag #1 or UserTag #2.

As explained above, the communication request which is requesting the establishment of communication service with an identified user may be initiated by the network entity 150 using the network address of the user terminal emulation application and identity of the user which were earlier registered with the network entity 150. However, the communication request may additionally or alternatively be generated by one of the I/O user devices 130 responsive to a command received from a proximately located user. For example, a user tag may operate automatically or through action of the user to initiate communications with one of the I/O user devices 130. Alternatively, a user may operate a user interface provided by one of the I/O user devices 130 to initiate a combined audio and video call with another user. The user terminal emulation server 100 (e.g., the I/O device handler (IODH) or the user terminal emulation application 110 for that user) receives the communication request along with the identity of the user tag. The application 110 performs the identifying, providing, routing, selecting, and combining operations described above to set up and operate a communication service between the user and the other user via the network entity 150.

Further example systems and related operations will now be described to further illustrate how I/O user devices having different UI capabilities can be operationally used or combined to provide a combined UI that can be used by user to satisfy the communication requirements of a communication service.

Further illustrative operations are described regarding an example embodiment in which a speaker device is one of the I/O user devices 130 in the set capable of playing a received audio stream and a microphone device is one of the I/O user devices 130 in the set capable of sensing audio to provide a microphone stream. Operations by the user terminal emulation application include updating the database 120 based on content of registration messages from the speaker device and the microphone device to identify network addresses of the speaker device and the microphone device, and to identify UI capabilities of the speaker device as having a speaker capability and the microphone device as having a microphone capability. The speaker UI capabilities may identify a number of speakers provided, sound loudness capability, and/or other operational characteristics. The microphone UI capabilities may identify a number of microphones provided, sensitivity of the microphones, and/or other operational characteristics. The speaker device and the microphone device are each identified as belonging to the set of I/O user devices that are determined to be proximately located to the location of the user (e.g., UserTag #1) and are further determined, based on the UI capabilities identified by the database 120, to satisfy the UI capability rule for used individually or combined to provide a combined I/O UI for the user to interface with the user terminal emulation application 110 to provide the communication service. Based on determining that the speaker device and the microphone device satisfy the UI capability rule, further operations are performed to route a microphone stream received from the microphone device toward the requesting user terminal (e.g., via network entity 150). When an audio stream is received as communication traffic from the requesting user terminal the operations select the speaker device based on matching an audio characteristic of the audio stream to the speaker capability identified by the database 120 for the speaker device, and then route the audio stream toward the network address of the speaker device.

The example embodiment may include, when a display device is one of the I/O user devices in the set capable of displaying a received video stream, the operations update the database 120 based on content of registration messages to identify network addresses of the display device, and to identify UI capabilities of the display device as having a display capability. The display UI capabilities may identify a screen display size, aspect ratio, pixel resolution, video frame rates supported, whether display device supports shared user support via split screen configuration, and/or other operational characteristics. The display device is also identified as among the set of I/O user devices that determined, based on the UI capabilities identified by the database 120, to satisfy the UI capability rule for being used individually or combined to provide the combined I/O UI for the user to interface with the user terminal emulation application 110 to provide the communication service. In an optional further embodiment, the set of I/O user devices is further selected based on each of the I/O user devices satisfying a rule for being proximately located to the location of the user. Based on determining that the speaker device, the display device, and the microphone device satisfy the UI capability rule, further operations respond to receipt of video stream as communication traffic from the requesting user terminal by selecting the display device based on matching a video characteristic of the video stream to the display capability identified by the database 120 for the display device, and then routing the video stream toward the network address of the display device.

In the example embodiment the operations for routing the audio stream and the video stream toward the network addresses of the speaker device and the display device, respectively, may include when audio data and video data are received within a same stream from the requesting user terminal through a first communication session: separating the audio data from the video data; routing the audio data toward the network address of the speaker device through a second communication session; and routing the video data toward the network address of the display device through the second communication session or a third communication session.

The example embodiment may include, when a camera device is one of the I/O user devices in the set capable of providing a camera stream, the operations update the database 120 based on content of a registration message to identify a network address of the camera device and to identify a UI capability of the camera device as having a camera capability. The camera UI capabilities may identify a camera pixel count, image quality, light sensitivity, and/or other operational characteristics. The camera device is further identified as a member of the set of I/O user devices that are determined to be proximately located to the location of the user and is further determined, based on the UI capability identified by the database 120, to satisfy the UI capability rule for being used individually or combined with the other I/O user devices in the set to provide the combined I/O UI for the user to interface with the user terminal emulation application 110 to provide the communication service. Based on determining that the camera device satisfies the UI capability rule, further operations are performed to route the camera stream received from the camera device toward the requesting user terminal, e.g., via the network entity 150.

The operations for routing the microphone stream received from the microphone device and the camera stream received from the camera device toward the requesting user terminal, can include: receiving the microphone stream from the microphone device through a first communication session; receiving the camera stream from the camera device through the first communication session or a second communication session; combining the microphone stream and camera stream in a combined stream; and routing the combined stream toward the requesting user terminal through a third communication session, e.g., via the network entity 150.

The example embodiment may include, when a keyboard device is one of the I/O user devices in the set capable of outputting key selection data responsive to key selections by a user among keys of the keyboard device, the operations can update the database 120 based on content of a registration message to identify a network address of the keyboard device and to identify a UI capability of the keyboard device as having a keyboard capability. The keyboard device capabilities may identify a key count, indication of whether the keyboard is a physical keyboard or a touch sensitive input device, and/or other keyboard capabilities. The keyboard device is further identified as a member of the set of I/O user devices that are determined to be proximately located to the location of the user and is further determined, based on the UI capability identified by the database 120, to satisfy the UI capability rule for being used individually or combined with the other I/O user devices in the set to provide the combined I/O UI for the user to interface with the user terminal emulation application 110 to provide the communication service. Based on determining that the keyboard device satisfies the UI capability rule, further operations are performed to identify commands formed by the key selection data received from the keyboard and to perform operations that have been predefined as being triggered based on receipt of the identified commands.

The operations for routing the key selection data received from the keyboard device and microphone stream received from the microphone device, may include: receiving the key selection data from the keyboard device through a first communication session receiving the microphone stream from the microphone device through the first communication session or a second communication session; combining the key selection data and the microphone stream in a combined stream; and routing the combined stream toward the requesting user terminal through a third communication session, e.g., via the network entity 150.

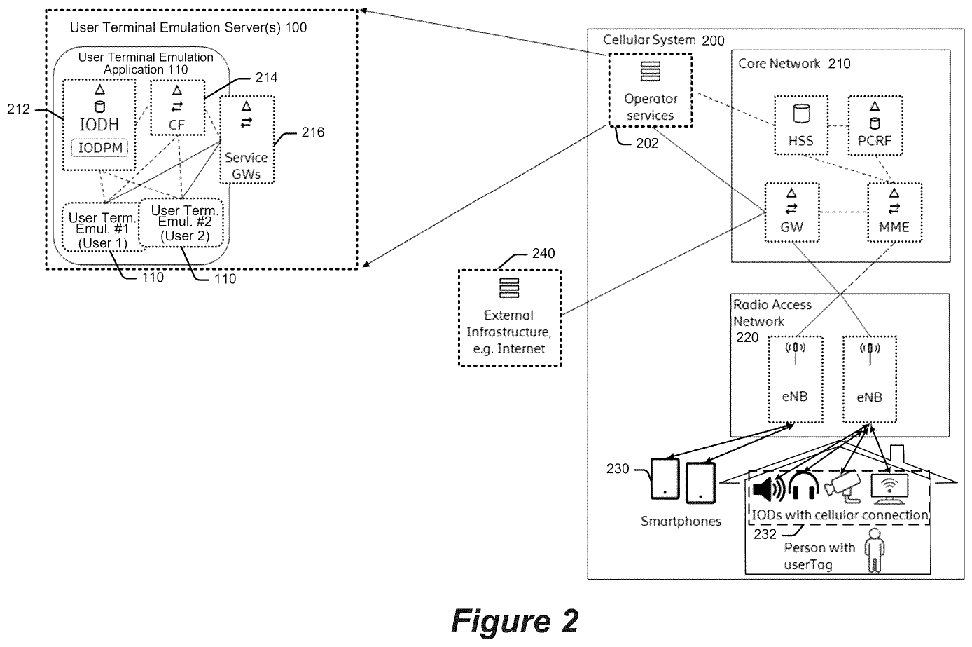

FIG. 2 is a block diagram illustrating the user terminal emulation server 100 as an element of an operator service node 202 within a cellular system 200. Referring to FIG. 2, the communication service function of the network entity 140 (FIG. 1) may be provided by the operator service node 202 or may be reached through external infrastructure 240, e.g., the Internet. The server 100 may, for example, be implemented in the radio access network 220 to provide edge computing with faster responsiveness or may be implemented within another node of the cellular system 200. The user terminal emulation server 100 can include an I/O user device handler (IODH) 212, a control function (CF) 214, the instantiated user terminal emulation applications 110, and a service gateway (GW) 216. A user terminal emulation application 110 may perform one or more user applications which are provided by a smart phone, such as a Netflix application, Facebook application, Microsoft Teams application, Internet browser application, etc.

The user terminal emulation server 100, or the IODH 212 which can be part of the server 100, may perform operations to manage the I/O user devices, such as to handle maintenance of the database 120, perform registration of I/O user devices to be available for use by the user terminal emulation applications 110, and manage mobility through operations for setting up and performing handover of communication services through I/O user devices. For example, the user terminal emulation server 100 may operate to identify the IP address of a user terminal emulation application, e.g., which encapsulates a Microsoft Teams application, for a subscriber with a service provider, e.g., a Microsoft Teams server. In some other embodiments, the IODH 212 may be located outside the user terminal emulation server 100 in another network node of the system. The CF 214 may be responsible for assigning an IP address to each user terminal emulation application 110. The IP address to be assigned by the CF 214 may be received from the core network 210 functionality such as a PDN-GW. The service GW 216 may interconnect the user terminal emulation server 100 to a PSTN network, packet data network gateway of a 3GPP (3^{rd} Generation Partnership Project) system, etc. The cellular system 200 can include a Core Network 210 having a Home Subscriber Server (HSS), a Policy and Charging Roles Function (PCRF), gateway (GW) and Mobility Management Entity (MME) providing control signaling related to mobile terminal mobility and security for the radio access. The HSS contains subscriber-related information and provides support functionality for user authentication and user access to the system. The PCRF enables QoS control per data flow and radio bearer, by setting QoS rules for each data flow, based on operator set policies and subscriber information. The GW can include a Serving GW (S-GW) and a Packet Data Network GW (PDN-GW), where the S-GW interconnects the core network 210 with the radio access network 220 and routes incoming and outgoing packets for the I/O user devices 232 and/or 130 and the user terminals 230. The PDN-GW interconnects the core network 210 with external infrastructure 240, such as the Internet, and allocates IP-addresses and performs policy control and charging.

Some I/O user devices 232 having cellular communication capability can communicate via, e.g., eNBs or other radio access nodes of a Radio Access Network 220 with the operator service node 202 via the core network 210. In the system of FIG. 2, the user terminal emulation server 100 may handle set up of a communication service between a selected set of the I/O user devices that are proximate to a user and a remote user terminal 230 (e.g., smart phone) via the cellular system 200.

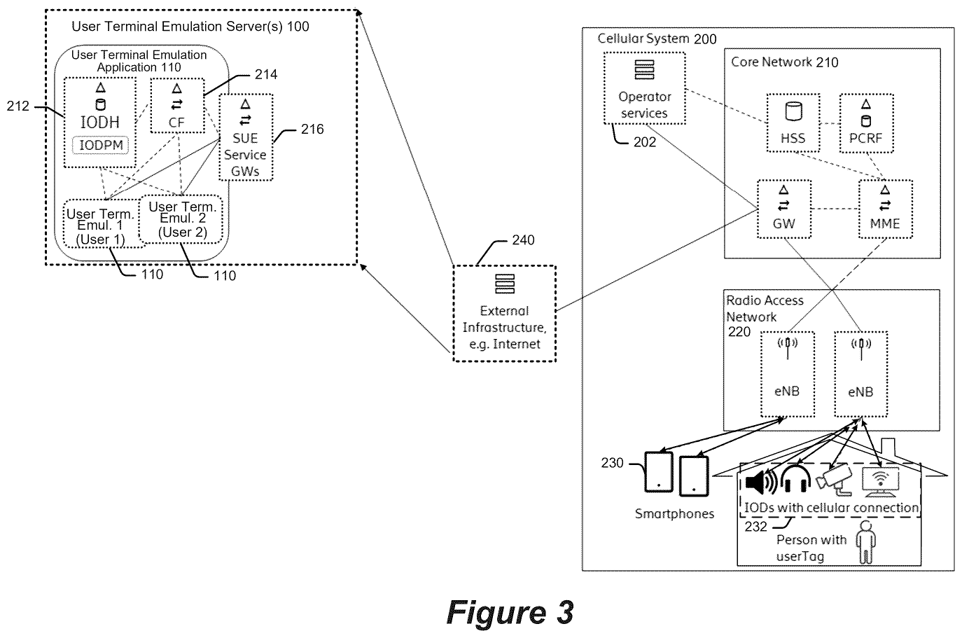

FIG. 3 is a block diagram illustrating the user terminal emulation server 100 communicating in a different manner with various elements of a cellular system 200, which may operate as the network entity 140 (FIG. 1), to provide communication services in accordance with some embodiments of the present disclosure. The system of FIG. 3 differs from the system of FIG. 2 by the user terminal emulation server 100 being an Internet service within external infrastructure 240 outside of the cellular system 200. In the system of FIG. 3, the CF 214 may determine the IP address to be assigned to different ones of the user terminal emulation applications 110 based on signaling from the Internet service within the external infrastructure 240.

The above and other example operations will now be described in further detail in the context of two different example “use cases”: 1) incoming call scenario; and 2) outgoing call scenario.

### Use Case 1: Incoming Call Scenario Operations are Now Discussed Below.

This use case involves a user, with a user tag or other way of being identified, being proximately located to I/O user devices 130 having different UI capabilities when an incoming call is received by the user terminal emulation server. Although operations are explained below in the context of identifying a user through a physical user tag transported by the user, these operations are not limited thereto and may be used with any other way of identifying a user, such as by sensing biometric information that identifies the user and involving operational communications with the user tag transported by the user.

A user terminal emulation application 110 may be instantiated or otherwise activated responsive by an incoming call (service, session) targeting the user tag. The user terminal emulation application 110 can identify subscriptions associated with the user tag (e.g., registered in a user account) and preferred methods of communication (e.g., audio not video, audio and video, etc.) that have been specified by the user, and determines the UI capabilities of the I/O user devices that will be needed to satisfy the UI capabilities which may be specified for the incoming communication session. The user terminal emulation application 110 may ask the IODH to identify which I/O user devices 130 are proximately located to the user tag, and may further ask the IODH to determine or may determine itself whether the identified I/O user devices 130 are usable individually or combinable to satisfy the UI capabilities specified by the incoming communication session. The user terminal emulation application 110 and/or the IODH may receive an ACK or NACK back on whether a sufficient set of I/O user devices 130 can be used to provide the communication service. If ACK, then the IODH also sets the state of the I/O user devices 130 in the set to in-use to avoid another user terminal emulation application 110 attempting to utilize the same I/O user devices 130 as which are presently in use.

In case of NACK, the user terminal emulation application 110 and/or the IODH can take different actions to setup a reduced UI capability communication service with the user depending on user settings, e.g., only allow sound-based communications instead of a combination of sound and video responsive to when no display device is presently available for use. An example of no display device being available may occur when the only display device that is proximately located to the user is presently being used by another user to receive information from another user terminal emulation application during an ongoing communication service or when no display device is proximately located to the user.

Further operations by user tags, I/O user devices, and the user terminal emulation server are described in accordance with this example use case. A user tag enters a room and signals its presence to any proximately located and capable I/O user device in the room using a discovery beacon signal. Alternatively, one or more of the I/O user devices determines presence of the user tag by polling, such as by periodically transmitting discover beacon signals that trigger responsive signaling by the user tag. The I/O user devices that receive signaling indicated presence of the user tag report to the IODH 212 along with a network address of the I/O user device (e.g., IP address, port number, MAC address, FQDN, etc.). The IODH 212 may be executed by the user terminal emulation server as part of the user terminal emulation application, by the I/O user devices, and/or by another computing node of the system. The user terminal emulation application corresponding to the specific user (i.e., the user tag) is updated with respect to the detected user's presence. The IODH 212 may operate to receive the notifications from the I/O user devices proximately located to the user tag. Further UI capability discovery (synchronization) communications are performed between the user terminal emulation server and the I/O user devices. The I/O user devices are associated to the user in the database 120, along with associated indications subscriptions, combinable UI capabilities provided by the set of I/O user devices which are proximately located to the user tag. One or more of the I/O user devices may be selected for default call reception ACK/NACK. The user via the user tag is now known to be reachable within the system through an identified set of I/O user devices with identified UI capabilities (e.g., speakers yes/no, display yes/no, microphone yes/no, keyboard yes/no, etc.), thereby creating a logical virtualized user terminal through which the user may be provided in a communication service. The user may initiate a communication service through a touchscreen, voice command sensed by a microphone, performing a defined gesture observable by a camera, and/or other input provided to one of the proximately located I/O user devices.

An incoming session (e.g., video call) from a requesting user terminal which is directed to the user (user tag) arrives at the user terminal emulation server for the user carrying the user tag. The individual or combinable UI capabilities of the available I/O user devices is compared to the UI requirements of the incoming session. When the UI requirements of the incoming session are not satisfied by the UI capabilities of the I/O user devices, the user terminal emulation server may renegotiate the required UI capabilities (e.g., QoS) of the incoming session. In contrast, when the UI requirements of the incoming session are satisfied the user terminal emulation server prompts, via one or more of the available I/O user devices (e.g., a pre-selected answer device), the user carrying the user tag to provide a session request answer (ACK/NACK). The user responds through the pre-selected answer device to accept (ACK) or reject (NACK) the incoming session, to provide signaling to the user terminal emulation server. When an ACK is received, operations route an audio stream from the requesting user terminal to one of the I/O user devices in the set that has a speaker capability via one or more sessions, and routes a video stream from the requesting user terminal to another one of the I/O user devices in the set that has a display capability via one or more sessions. A data stream that is received from one of the I/O user devices in the set through a one or more sessions is routed toward the requesting user terminal. When two or more data streams are received through one or more sessions from the I/O user devices, they can be combined into a combined data stream that is routed toward the requesting user terminal.

The user terminal emulation server or IODH may perform operations to continuously monitor presence of the I/O user devices to determine when one or more of I/O user devices is no longer proximately located to the user such that it can no longer be included as part of the combined UI be provided during the ongoing communication session. The user terminal emulation server or IODH may substitute the UI capability of another I/O user device to the set being used by the user for the ongoing communication session responsive to a previous member of the set no longer having required presence.

### Use Case 2, Outgoing Call Operations are Now Discussed Below.

This use case involves a user, with a user tag, being proximately located to I/O user devices 130 having different UI capabilities when an outgoing call (communication session) is received by the user terminal emulation server. The I/O user devices 130 are associated to the identified user via the user terminal emulation server 100 which handles all communications sessions for the user while the associated I/O user devices 130 are managed by an IODH 212.

A user terminal emulation application 110 may be instantiated or otherwise activated responsive by an outgoing call being requested by a user carrying the user tag. The user may initiate an outgoing call through a touchscreen, voice command sensed by a microphone, performing a defined gesture observable by a camera, and/or other input provided to one of the proximately located I/O user devices.

The user terminal emulation application 110 can identify subscriptions associated with the user tag and preferred methods of communication (e.g., audio not video, audio and video, etc.) that have been specified by the user, and determines the UI capabilities of the I/O user devices that will be needed to satisfy the UI capabilities which may be specified for the outgoing call. The user terminal emulation application 110 may ask the IODH 212 to identify which I/O user devices 130 are proximately located to the user tag, and may further ask the IODH 212 to determine or may determine itself whether the identified I/O user devices 130 are individually useable or combinable to satisfy the UI capabilities specified by the outgoing call. The user terminal emulation application 110 and/or the IODH 212 may receive an ACK or NACK back on whether one or a set of I/O user devices 130 can be used to provide the communication service. If ACK, then the IODH 212 also sets the state of the one or more I/O user devices 130 in the set to in-use to avoid another user terminal emulation application 110 attempting to utilize the same I/O user device(s) 130 as which are presently in use. In case of NACK, the user terminal emulation application 110 and/or the IODH 212 can take different actions to setup a reduced UI capability communication service with the user depending on user settings, e.g. only allow sound instead of the preferred sound and video responsive to when no display device is presently available for use (e.g., when presently used by another user terminal emulation application 110 or when none is proximately located to the user tag).

Example operations for an outgoing call and related data flows between user tags, I/O user devices, and the user terminal emulation server are now described in the context of this use case. A user tag enters a room and signals its presence to any proximately located and capable I/O user device in the room using a discovery beacon signal. Alternatively, one or more of the I/O user devices determines presence of the user tag by polling, such as by periodically transmitting discover beacon signals that trigger responsive signaling by the user tag. The I/O user devices that receive signaling indicated presence of the user tag report to the IODH 212 along with a network address or other identifier of the I/O user device (e.g., IP address, port number, MAC address, FQDN, etc.). The IODH 212 may be executed by the user terminal emulation server as part of the user terminal emulation application, by the I/O user devices, and/or by another computing node of the system. The user terminal emulation application corresponding to the specific user (i.e., the user tag) is updated with respect to the detected user's presence.

The IODH 212 may operate to receive the notifications from the I/O user devices proximately located to the user tag. Further UI capability discovery (synchronization) communications are performed between the user terminal emulation server or the IODH and the I/O user devices. The I/O user devices are associated to the user in the database 120, along with associated indicated service subscriptions and combinable UI capabilities provided by the set of I/O user devices which are proximately located to the user tag. One or more of the I/O user devices may be selected for default call reception ACK/NACK. The user via the user tag is now known to be reachable within the system through an identified set of I/O user devices with identified UI capabilities (e.g., speakers yes/no, display yes/no, microphone yes/no, keyboard yes/no, etc.), thereby creating a logical virtualized user terminal through which the user may be provided in a communication service. The user may initiate a communication service through a touchscreen, voice command sensed by a microphone, performing a defined gesture observable by a camera, and/or other input provided to one of the proximately located I/O user devices.

A user carrying the user tag uses the UI of one of the I/O user devices to trigger an outgoing call (e.g., video call), which triggers signaling of the outgoing call to the user terminal emulation server. The IODH 212 and/or the user terminal emulation application queries the user (e.g., displays a message, generates a sound, etc.) through one of the I/O user devices proximately located to the user to request the user to select among available types of communication methods that can be presently used for the outgoing call. One of the I/O user devices provides responsive signaling to the IODH 212 or user terminal emulation server 100 indicating the user's selected type of communication method for the outgoing call. The user terminal emulation server communicates an outgoing session stream request to the network entity 150, where the request may include an identifier of the calling user, identifier of the user terminal of the called user, and a quality of service for the communication session. The user terminal emulation server receives a communication session acceptance (ACK) or denial (NACK) from the network entity 150. When the communication session is denied, the user terminal emulation server may attempt to renegotiate the requested communication session such as at a lower quality of service.

When the communication session is accepted (ACK), for each data type that is received as communication traffic from the requested user terminal, the user terminal emulation server selects one of the I/O user devices from among the set of I/O user devices based on matching characteristics of the data type to the UI capabilities identified by the database 120 for the one of the I/O user devices, and then routes the data of the data type toward the network address of the selected one of the I/O user devices. The I/O user devices transmit data streams through one or more sessions to the user terminal emulation server, which may combine the data streams into a combined data stream that is routed toward the called user terminals via the network entity 150.

The user terminal emulation server or IODH may continuously monitor presence of the I/O user devices to determine when one or more of I/O user devices is no longer proximately located to the user such that it can no longer be included as part of the combined UI be provided during the ongoing communication session. The user terminal emulation server or IODH may substitute the UI capability of another I/O user device to the set being used by the user for the ongoing communication session responsive to a previous member of the set no longer having required presence.

### Security Issues and Related Operations are Now Discussed Below.

It can be desirable in some system to provide operation for a virtual instance, e.g., virtual terminal emulation application 110, in the cloud, e.g., user terminal emulation server 100, to dynamically secure use of physical resources using authentication and key establishment procedures.

Some embodiments are directed to using a trusted party (function) to enable secure access and communications between a cloud service, e.g., user terminal emulation server 100 (also “Cloudphone”) and I/O user device(s) 130. Some embodiments are directed to extending existing authentication functions to establish a secure association among various elements of the systems described regarding FIGS. 1-3 and, in particular, between the user terminal emulation server 100, the I/O user device(s) 130 which are proximately located to a user, and the user tag transported by the user.

In some embodiments, the user, who has been registered and authenticated to a cloud service, carries a user tag which has been associated (e.g., by a user identity) to the user terminal emulation server 100 such in the database 120. As explained above, there can be numerous I/O user devices 130 that are associated and registered to a lookup service, e.g., IODH 212.

When a user enters the close proximity of at least one I/O user device 130, operations are performed based on Extensible Authentication Protocol (EAP), Authentication and Key Management for Applications (AKMA), or another security function to establish a secure association between the user terminal emulation server 100, the I/O user device(s) 130 proximately located to the user, and the user tag transported by the user. The secure association enables the user terminal emulation server 100 to utilize the UI capabilities of those I/O user device(s) 130 to obtain a communication service.

In some example scenarios, the user tag (also) restrained device, is transported by a user to identify the user and can be capable of short-range radio signalling, e.g., near-field communication (NFC), Bluetooth, etc., and/or log-range radio signalling, e.g., WiFi, cellular, etc. The user tag is registered and authenticated to the I/O user device(s) 130. At least one I/O user device 130 has a local service providing certain UI capabilities which can be registered with the user terminal emulation server 100 or IODH 212 for inclusion in a lookup service provided through a database, e.g., database 120 and/or which may reside in the IDOH 212 and/or the I/O user devices 130.

Although some embodiments are described in the context of the user terminal emulation server 100 being a cloud-based service, these and other embodiments are not limited thereto. Operations disclosed herein can be used to enable an authenticated user to securely couple physical resources, residing on separate private networks, to a cloud-based service. The cloud-based service may be a phone service, video conference service, streaming media service, video on-demand service, audio on-demand service, web service, digital assistant service, service technician service and/or any other service which may operate to communicatively connect to physical resources in the proximity of a user.

Various embodiments are now separately explained in the context of EAP-based authentication operations and the context of AKMA-based authentication operations, although the operations may be used with any security function operations which can facilitate secure access. In some embodiments, the user terminal emulation server 100 performs operations to establish a secure channel connection with a first I/O user device 130 using a session identifier and an identifier associated with the first I/O user device to determine a first I/O user device specific key generated from a master key, the first I/O user device specific key and the session identifier being used for secure communication of messages with the first I/O user device. The operations receive an indication of an I/O user interface capability of the first I/O user device 130 through the secure channel connection with the first I/O user device 130. The operations communicate with the first I/O user device 130 to use the I/O user interface capability to provide at least part of the communication service for a user.

These and other related operations are first described in the EAP-based authentication context and then described in the AKMA-based authentication context.

### EAP-Based Authentication and Related Operations are Now Discussed Below.

EAP is an authentication framework which supports multiple authentication methods. EAP typically runs directly over data link layers such as Point-to-Point Protocol (PPP) or IEEE 802, without requiring IP. EAP provides its own support for duplicate elimination and retransmission but is reliant on lower layer ordering guarantees. Fragmentation is not supported within EAP itself; however, individual EAP methods may support fragmentation.

EAP is a two-party protocol spoken between the EAP peer and server. Within EAP, keying material is generated by EAP authentication algorithms, known as “methods”. Part of this keying material can be used by EAP methods themselves, and part of this material can be exported. In addition to the export of keying material, EAP methods can also export associated parameters such as authenticated peer and server identities and a unique EAP conversation identifier, and can import and export lower-layer parameters known as “channel binding parameters”, or simply “channel bindings”.

From RFC 5247: “EAP methods supporting key derivation and mutual authentication SHOULD export a method-specific EAP conversation identifier known as the Session-Id . . . ”. Exporting can entail providing the exported information to the EAP authenticator.

An example, flow of an EAP exchange for access authentication (802.1x used for WLAN/LAN), can include the device attaching to an authenticator point (AP). This means an (e.g.) 802.11 association is established between device and AP. The AP requests the identity of the device with an EAP identity request message. The device replies with its identity in an EAP response message. The AP, which works as an Authenticator, forwards the identity in a RADIUS or DIAMETER access request message to the authentication server.

The authentication server replies with a challenge for the device and indicating the EAP method to be used. The AP forwards the request in an EAP request message to the device. The device responds to the EAP message with an EAP response message. The AP forwards the response in a RADIUS or DIAMETER message to the authentication server. EAP messages are exchanged between the device and the authentication server until the authentication server has authenticated the device using the chosen method. The authentication server sends a RADIUS or DIAMETER access accept message, containing a pairwise master key (PMK) to the AP. The AP keeps the PMK and forwards the success in an EAP success message to the device. The device generates the corresponding PMK. The device is authenticated and the AP and device can use the PMK to configure access security. EAP can also be run towards Authenticators other than WLAN APs, and the Authenticator can be co-located with/part of the Authentication server.

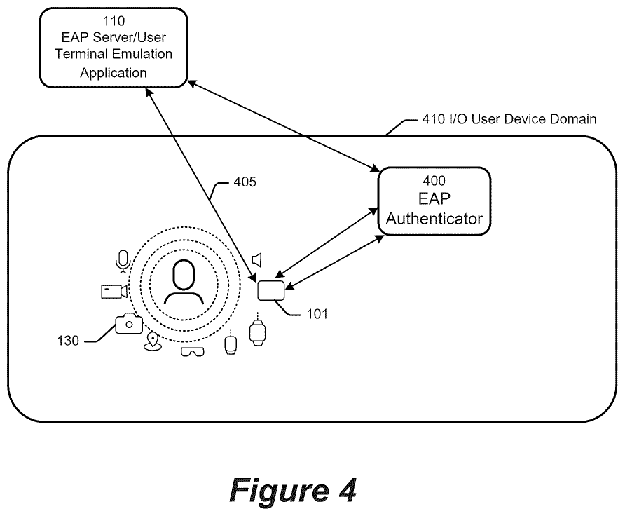

EAP-based operations between a user tag 110 and the user terminal emulation server 110, which can operate an EAP server (function), are now described with reference to FIG. 4. FIG. 4 illustrates a combined flowcharts of operations and related data flows between the user terminal emulation application 110 and elements of an I/O device (IOD) domain 410, such as I/O user devices 130, a lookup service/IODH, and an Extensible Authentication Protocol (EAP) authenticator 400 in accordance with some embodiments of the present disclosure. For brevity when discussing various example operations below, the term “I/O device” is abbreviated as “IOD”.

Referring to FIG. 4, an assumption in the EAP-based approach is that the user tag is transported with the user and contains circuitry which is configured to operate as an EAP client. The user tag therefore has at least limited communication and computational capabilities. An example user tag can be a smart card with NFC or other short-range communication such as capacitive communication coupling, or can be an electronic device with Bluetooth and/or other communication capabilities. The I/O user devices 130 are registered with their (local) IODH 212, which functions as a lookup service for I/O user devices (IOD A . . . IOD x) in the local IOD domain 410, i.e., the IODH 212 has information characterizing the I/O user devices (IOD A . . . IOD x) which may include an identifier, authentication credentials (e.g. public key of I/O user devices (IOD A . . . IOD x), location of I/O user devices (IOD A . . . IOD x) geographic coordinates, room numbers, floor numbers, etc., defining type information, defining UI capabilities, etc. In some embodiments, the user terminal emulation application 110 may be executed within the IOD Domain 410, such as with the EAP Authenticator 400 and/or the IODH 212. Executing the user terminal emulation application on the same computing node or on a locally networked node as the EAP authenticator and/or IODH can simplify and reduce system resources consumed to exchange information and other communications therebetween.

Which users and/or user terminal emulation applications are allowed to interact with the I/O user devices (IOD A . . . IOD x) in the IOD domain 410 can be determined based on access control policies which can reside in the IODH 212 and may vary depending on use case scenario, e.g., semi-public domain, such as a hotel vs. private domain such as an enterprise office complex.

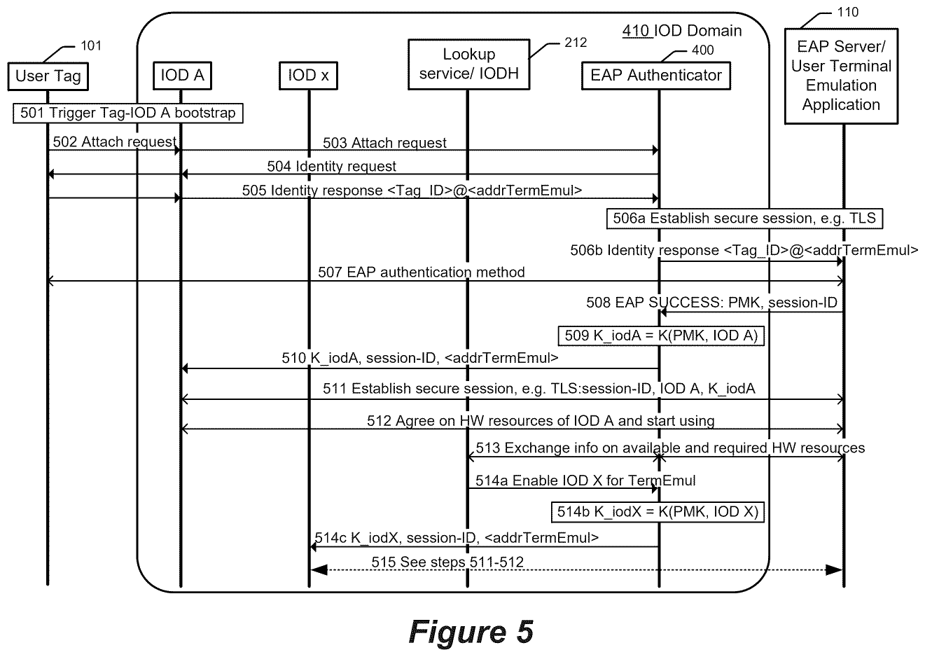

In the scenario of FIG. 5, a user who is transporting a user tag 101, e.g., dongle, wants to utilize a proximately located I/O user device (IOD A). The user may trigger the I/O user device (IOD A), by pushing a button on the user tag 101, triggering a command responsive to the user tag seeing a Service Set IDentifier (SSID) or Bluetooth (BT) address of the I/O user device (IOD A), and/or the I/O user device (IOD A). For example, the user may activate or initiate attention from the I/O user device (IOD A) using the user tag over NFC (i.e. very close proximity), and/or by the user pushing a button on the I/O user device to initialize a bootstrapping process 501.

The user tag sends 502, via the I/O user device (target), an attach request to the system where the I/O user device is connected. The attach request is forwarded 503 by the I/O user device to the EAP Authenticator 400 in the system. The EAP authenticator 400 may be a local process in the I/O user device (IOD A) or in the IODH 212 of the user terminal emulation server 100, or may reside as a separate entity in the IOD domain 410. The attach request may therefore be processed by the I/O user device itself, i.e., where multiple EAP Authenticators are present in the system, be processed by the IODH 212, or be processed by the EAP authenticator 400.

The EAP authenticator 400 responds 504 with an EAP identity request, which is communicated back to the user tag 101.

The user tag 101 responds 505 with an EAP response, which carries the identity of the user tag 101. The identity identifies the user tag 101 (e.g., holder of user tag, such as the user) and points to the user terminal emulation application 110 associated with the user tag 10. The identity may be <hash(user_pub_key)>@<user_terminal emulation application_address>. The hash of the public key provides a more compact identity of the public key of the user tag 101, and may be included with a network address of the user terminal emulation application 110. As explained above, the user terminal emulation application 110 may provide a communication service function corresponding to, for example, an over-the-top Voice Over Internet Protocol (VoIP) service, Netflix service, Facebook service, Microsoft Teams meeting service, Internet browser service, a cellular communication service, etc.

When the user tag 101 has been issued to the user, it may have also been associated with the corresponding user terminal emulation application 110. This means that the user tag 101, in addition to its own credentials (e.g., public key pair), can be configured to have reachability information of the user terminal emulation application 110, e.g., a Fully Qualified Domain Name (FQDN), as well as credentials for authentication of the user terminal emulation application 110 (e.g., public key of user terminal emulation application 110). Likewise, the user terminal emulation application 110 may have been configured with the credentials of the user tag 101 (e.g., public key of user tag 101). This means that the user terminal emulation application 110 knows that the user tag 101 is an entity that is authorized to request data streams and services from the user terminal emulation application 110.

The EAP authenticator 400 identifies the user terminal emulation application 110 based on the realm part of the identifier and forwards the request to the user terminal emulation application 110, which is here acting as the EAP server (referred to as “EAP server/user terminal emulation application 110” for brevity).

The EAP authenticator 400 first establishes 506a secure connection between itself and the EAP server/user terminal emulation application 110. The EAP messages are passed over that secure channel between authenticator and EAP server/user terminal emulation application 110. The secure connection may be a Transport Layer Security (TLS) session. The EAP Authenticator 400 knows it needs to talk with the EAP server/user terminal emulation application 110 based on the identity (realm part of identity) received 506b in EAP Identity Response. It also knows it needs to have a secure channel with the EAP server/user terminal emulation application 110. Thus, if there is not an existing secure session (typically TLS), the EAP Authenticator 400 creates the secure session and then forwards 506b the Identity response to the EAP server/user terminal emulation application 110. The communication between the EAP Authenticator 400 and the EAP server/user terminal emulation application 110 function of the user terminal emulation application 110, while using EAP messages, may be carried by DIAMETER or RADIUS protocol.

The user terminal emulation application/EAP server 110 and the user tag 101 will perform an EAP exchange 507 to authenticate the user tag 101 to the user terminal emulation application 110. The EAP server/user terminal emulation application 110 may also be authenticated to the user tag 101. The authentication may require multiple messages to be exchanged between the user tag 101 and the EAP server/user terminal emulation application 110 via the EAP authenticator 400.

Once the user tag 101 and possibly also the EAP server/user terminal emulation application 110 is/are successfully authenticated, the EAP server/user terminal emulation application 110 can send 508 a final EAP SUCCESS message to the EAP authenticator 400. The EAP SUCCESS message also carries the master key, e.g., pairwise master key (PMK), and the session-ID. The PMK key is the master key for the session-ID, the PMK key can be used to derive more keys for I/O user devices, e.g., IOD X, added to this session.

In an optional operation, the user tag 101 at this stage may derive the master key, e.g., PMK key, but it will not (necessarily) be used by the user tag 101. The master key can be used if the user wants to authorize additional I/O user devices, e.g., IOD X, assuming the user is more in control of which I/O user devices are added to the session by having to actively (possibly even physically) add more I/O user devices to the EAP server/user terminal emulation application 110.

The authenticator generates 509 an I/O user device specific key K_iodA from the received keying material to be used for streaming data between user terminal emulation application 110 and the target I/O user device IOD A. Generating the I/O user device specific key K_iodA may include using the received keying material as is, or may include performing a computational operation on the received key material such as by hashing a concatenation of the keying material and the identifier of the target I/O user device IOD A and/or using another key derivation function (KDF) based on PMK and I/O user device specific information.

The EAP authenticator 400 provides 510 the I/O user device specific key K_iodA to the I/O user device IOD A, together with the session-ID exported by the EAP server/user terminal emulation application 110 and the address (e.g. FQDN) of the user terminal emulation application 110.

The I/O user device IOD A can use the received data to establish 511 a secure channel (e.g., TLS) between itself and the user terminal emulation application 110. It is noted that in some embodiments, to establish the secure channel between I/O user device IOD A and the EAP server/user terminal emulation application 110 there needs to be a shared secret (which is the first I/O user device specific key K_iodA), an identifier for who is connecting to the EAP server/user terminal emulation application 110 (IOD A) and that is used to derive I/O user device specific key, and an identifier (session-ID) that the EAP server/user terminal emulation application 110 can use to lookup the context from where it can derive the corresponding K_iodA.

If the EAP Authenticator 400 is part of I/O user device IOD A, then the I/O user device could re-use the TLS session established in operation 506. However, a more scalable solution is enabled by using a uniform operation for all I/O user devices connecting to the EAP server/user terminal emulation application 110 so as to not have special cases in an implementation.

In operation 511, the I/O user device IOD A can use the session-ID to indicate to the EAP server/user terminal emulation application 110 the session/keying material/authentication context to which the connection request relates.

The EAP server/user terminal emulation application 110 locates context and associate keying material based on received session-ID. As background, the IOD A is to connect with the EAP server/user terminal emulation application 110 using a secure channel so the EAP server/user terminal emulation application 110 can stream or receive data from the IOD A, such that the IOD A needs to have keying material which it can use to establish a secure connection and the user terminal emulation application 110 needs to verify that the IOD A is authorized to send data. So, the session ID that was sent in operation 508 is what the IOD A can send to the EAP server/user terminal emulation application 110 so it knows the request relates to the authentication session that was setup for the session ID, and then locates its copy of the PMK key and any other keys negotiated during the authentication.

The I/O user device uses its own identifier (e.g. IOD A) as a kind of username. The IOD A thereby tells the EAP server/user terminal emulation application 110 who it is. The EAP authenticator 400 has derived an IOD A specific key based on the PMK key, e.g., by concatenating the IOD A ID and the PMK key and then hashing the concatenated string, and may truncate the hash value to a defined length. The EAP server/user terminal emulation application 110 needs to know the ID for the IOD A so it can derive the same IOD A specific key provided to IOD A in, e.g., step 510.

The EAP server/user terminal emulation application 110 uses the I/O user device identifier to derive IOD A specific key (K_iodA). The IOD A uses the received key K_iodA as the password/authentication credential to authenticate to the EAP server/user terminal emulation application 110. In this operation the I/O user device IOD A and the EAP server/user terminal emulation application 110 share the same IOD A specific key which is used as a shared secret that the EAP server/user terminal emulation application 110 and I/O user device IOD A use to authenticate each other and establish a secure channel therebetween. The EAP server/user terminal emulation application 110 verifies, via PSK-based authentication, that the I/O user device indeed possesses a valid session key (K_iodA) and is thus authorized to connect to the EAP server/user terminal emulation application 110 and exchange data with it. A secure channel is established between the I/O user device IOD A and the EAP server/user terminal emulation application 110.

The I/O user device IOD A, after successful authentication, can indicate 512 its UI capabilities (e.g., display, speaker, microphone, etc.) to the user terminal emulation application 110, which based on the UI capabilities, can enable data streaming to and/or from the I/O user device IOD A.

The user may have defined policies to the EAP server/user terminal emulation application 110 regarding what operations can be enabled automatically (e.g., streaming video to a display device for the communication service) and what operations requires explicit user consent before performing (e.g., to enable microphone use for the communication service)

In a parallel optional operation, the EAP server/user terminal emulation application 110 may operate to interact 513 with the IODH 212 regarding other I/O user devices in the vicinity of the user which have UI capabilities that can be used to provide the communication service to the user. These operations can provide the EAP server/user terminal emulation application 110 information about what UI and/or I/O capabilities could be available to the user for the communication service. Whether the EAP server/user terminal emulation application 110 may operate to interact 513 with the IODH 212 regarding other I/O user devices may depend on which service and/or application is running in the EAP server/user terminal emulation application 110.

This communication may be performed via an entity of the I/O user device domain 410 acting as an EAP authenticator 400 towards the EAP server/user terminal emulation application 110, and thereby the already established secure channel could be re-used. Alternatively, the EAP authenticator 400 may generate an IODH 212 specific session key (similar to what was performed for IOD A) and provide IODH 212 with all relevant info (e.g., K_iodh, session-ID, EAP server/user terminal emulation application 110 FQDN) for securely communicating with the user terminal emulation application 110.

The IODH 212 may itself be the EAP authenticator 400, in which case much of the “communication” between authenticator and IODH 212 is simplified, such as where the PMK is used directly by the IODH 212 to securely communicate with user terminal emulation application 110, or the already established secure session is re-used.

The communication may include the IODH 212 telling the user terminal emulation application 110 about which I/O user devices are available to the user, and may include the EAP server/user terminal emulation application 110 requesting certain HW resources from the IODH 212.

When the IODH 212 concludes, or the EAP server/user terminal emulation application 110 requests, that a certain other I/O user device (IOD X) should join the session established between the user and the IOD domain 410, the IODH 212 can request 514a the EAP authenticator 400 to generate credentials for the other I/O user device (IOD X), (e.g., K_iodx, session-ID, EAP server/user terminal emulation application 110 FQDN) and provide those credentials to the other I/O user device (IOD X).

The IODH 212 may send 514a a request based on the user instructing the EAP server/user terminal emulation application 110 (e.g., over connection with some already connected I/O user device) or based on local policy and/or configuration. The decision that a further I/O user device is required may be dependent upon: which application and/or service the user activates; ongoing application and/or service; available devices and their respective UI capabilities; and/or a defined configuration by the user to always try to find an I/O user device which has certain UI capability(ies).

If the other I/O user device IOD X receives 514c a trigger (e.g., where the trigger is the credentials etc. needed to connect to user terminal emulation application 110) from the EAP authenticator 400, the other I/O user device IOD X performs similar operations to the I/O user device IOD A as described above in operations 511 to 512.

More general operations are now described with respect to FIGS. 4 and 5.

Embodiments are not limited to the particular operations illustrated in FIG. 5 and discussed above. For example, the user tag 101 can more generally include circuitry that is configured to send 502 to a first I/O user device 130 (which may correspond to IOD A) an attach request, and receive 504 from the first I/O user device 130 an identity request by an authenticator 400. The user tag 101 then sends 505 to the I/O user device a response which contains an identifier of the user tag and an address of a user terminal emulation application 110 hosted by a user terminal emulation server 100. The user tag 101 then communicates 507 with the user terminal emulation application (110) to perform an exchange for mutual authentication and establish a master key used to generate one or more I/O user device specific keys.

The circuitry of the user tag 101 may be powered by NFC reader circuitry of the first I/O user device 130 to send 502 the attach request, to receive 504 the identity request, to send 505 the response, and to communicate 507 with the user terminal emulation application 110 to perform the exchange. The circuitry may be further configured to generate 505 the identifier of the user tag based on hashing a public key of the user tag.

The user terminal emulation server 100 is generally configured to provide a communication service through I/O user devices 130, and includes at least one processor 1200 (FIG. 8) and at least one memory 1220 (FIG. 8) storing program code that is executable by the at least one processor to perform operations. The operations include to establish 405 (FIG. 4) and 511 (FIG. 5) a secure channel connection with a first I/O user device (130) using a session identifier and an identifier associated with the first I/O user device to determine a first I/O user device specific key generated from a master key, where the first I/O user device specific key and the session identifier being used for secure communication of messages with the first I/O user device. The first I/O user device specific key may be determined based on the I/O user device identifier, such as an I/O user device key (e.g., KDF (PMK, I/O user device ID), where KDF is a key derivation function). The operations receive 405 and 512 an indication of an I/O user interface capability of the first I/O user device 130 through the secure channel connection with the first I/O user device 130. The operations communicate 405 and 512 with the first I/O user device 130 to use the I/O user interface capability to provide at least part of the communication service for a user.

The operations by the EAP server/user terminal emulation application 110 can further include to receive 506b an EAP response through a communication channel with the EAP authenticator 400, where the EAP response contains an identifier of a user tag 101. The operations communicate 507 with the user tag 101 to perform an EAP exchange for authentication and establish the master key, and send 508 an EAP success message to the EAP authenticator 400, where the EAP success message contains the master key and a session identifier associated with the master key. It is noted that the IOD A has communicated with the user terminal emulation application to authenticate with the IOD A specific key. Following the sending 508 of the EAP success message to the EAP authenticator 400, the operations perform the receiving 405 of the indication of the I/O user interface capability of the first I/O user device 130 and the communicating 405 with the first I/O user device 130 to use the I/O user interface capability to provide at least part of the communication service for the user.

The operations by the user terminal emulation server 100 can further include to store in the database 120 (FIG. 1) the identifier of the user tag allowed to access the communication service, a network address of the first I/O user device based on communications with the first I/O user device, the first I/O user device specific key, and the indication of the I/O user interface capability of the first I/O user device 130.

It is noted that initially the user terminal emulation server 100 (i.e., via the EAP server/user terminal emulation application 110) stores the session identifier and the PMK. When an I/O user device connects to the user terminal emulation server 100, the I/O user device provides its identifier to the user terminal emulation server 100 as part of the connection establishment procedure. The user terminal emulation server 100 can now generate the I/O user device specific key. Using the I/O user device specific key, the user terminal emulation server 100 can authenticate the I/O user device, and after which can establish the secure channel between the two. The I/O user device has obtained the corresponding key from the EAP Authenticator 400 in IOD domain 410. The I/O user device can likewise optionally authenticate the user terminal emulation application 110 using the key (i.e., verify that the user terminal emulation application 110 belongs in the session as it possesses a key associated with it). The I/O user device specific key can be generated by the user terminal emulation application 110 only after the user terminal emulation application 110 has learned the ID of the I/O user device specific key. In some embodiments, the EAP server/user terminal emulation application 110 learns the I/O user device identifier when the I/O user device tries to connect to the EAP server/user terminal emulation application 110.

In some embodiments, the order of events includes the I/O user device connects to the EAP server/user terminal emulation application 110 (with own ID, session ID and the I/O user device specific key). The EAP server/user terminal emulation application 110 identifies session context based on session ID. The EAP server/user terminal emulation application 110 derives the I/O user device specific key (and maybe stores in in the database 120). The EAP server/user terminal emulation application 110 and the I/O user device authenticate based on the I/O user device specific key. A secure channel can then be setup based on the I/O user device specific key.

The operations to establish 405 the secure channel connection with the first I/O user device 130 using the session identifier and the identifier associated with the first I/O user device to determine the first I/O user device specific key generated from the master key, can include to receive a secure channel connection request which includes the identifier of the first I/O user device 130 and the session identifier, and initiate the determination of the first I/O user device specific key based on the master key. The operations store the first I/O user device specific key in the database 120 with an association to the session identifier. The operations obtain the first I/O user device specific key from the database 120 using the session identifier, authenticate the first I/O user device based on the first I/O user device specific key, and setup the secure channel connection with the first I/O user device 130 responsive to authentication of the first I/O user device.

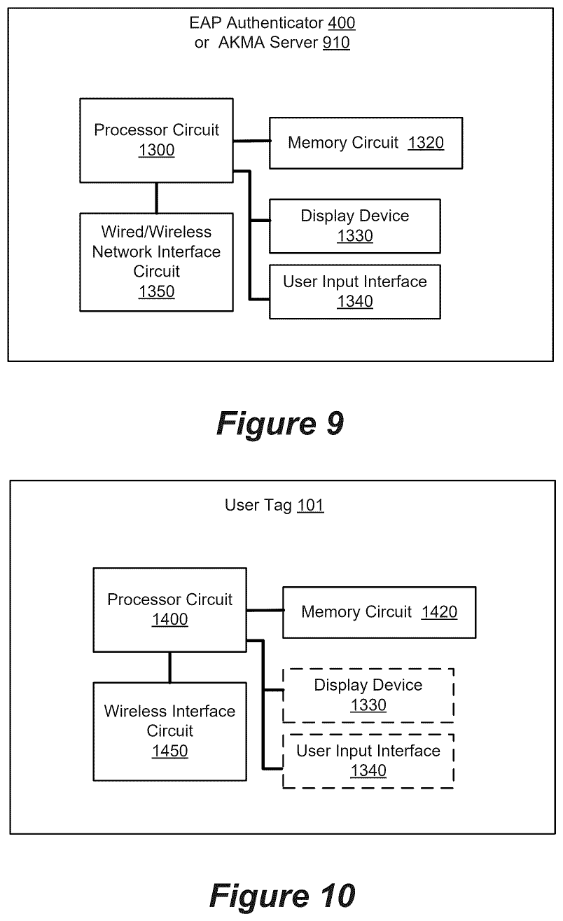

Corresponding operations by the EAP authenticator 400 are now described. The EAP authenticator 400 can include at least one processor 930 (FIG. 9), at least one memory 940 (FIG. 9) storing program code that is executable by the at least one processor to perform operations. The operations include to receive 505, from the first I/O user device 130, an EAP response which contains the identifier of the user tag containing an address of a user terminal emulation application 110 hosted by a user terminal emulation server 100. The operations establish 506a a communication channel with the user terminal emulation application 110 based on the address in the user tag of the user terminal emulation application 110, and send 506b at least one EAP message based on the EAP response through the communication channel with the user terminal emulation application 110. The EAP authenticator 400 also receives EAP messages from the user terminal emulation application 110. In general, the EAP Authenticator 400 passes EAP messages between the user tag 101 and the user terminal emulation application 110. The operations receive 508 an EAP success message from the user terminal emulation application 110, where the EAP success message contains a master key and a session identifier, and generate 509, based on the master key, a first I/O user device specific key. The operations then send 510 to the first I/O user device 130 the first I/O user device specific key, the session identifier, and the address for the user terminal emulation application 110.

The at least one EAP message may be sent 506b through the secure channel connection to the user terminal emulation application 110 using DIAMETER protocol or RADIUS protocol. The EAP authenticator 400 exchanges EAP messages between the user tag 101 and the user terminal emulation application 110.

The EAP authenticator 400 may generate 509 the first I/O user device specific key based on a key derivation function performed on the master key and an identifier of the first I/O user device 130.

The EAP authenticator 400 may obtain 513 an identifier of a second I/O user device 130 that is proximately located to the first I/O user device 130 and has an I/O user interface capability that satisfies a rule for being combinable with the I/O user interface capability of the first I/O user device 130 to provide a communication service, and generate 514b, based on the master key, a second I/O user device specific key. The EAP authenticator 400 may can then send 510 to the second I/O user device 130, the second I/O user device specific key, the session identifier, and the address for the user terminal emulation application 110.

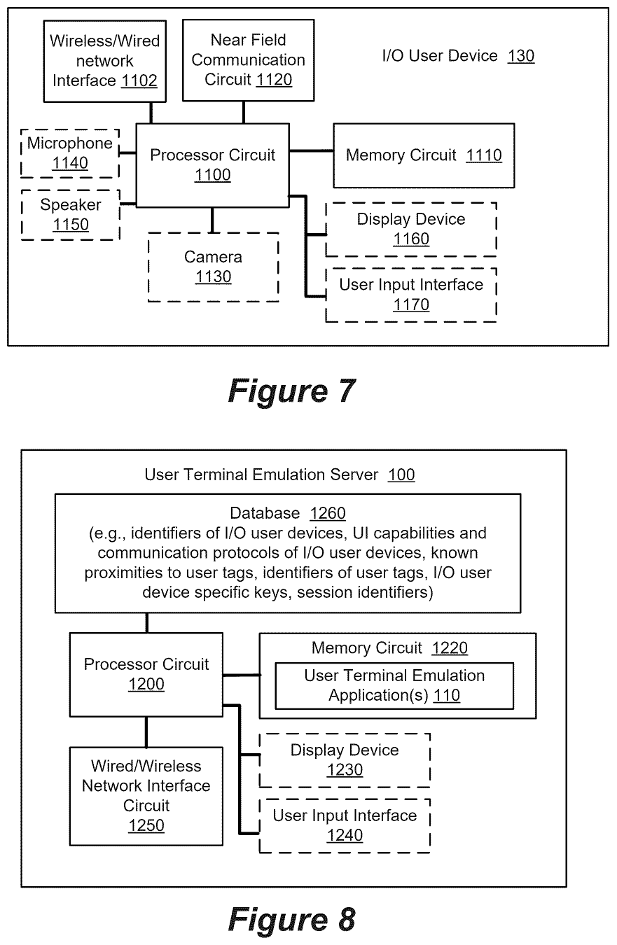

Corresponding operations by the first I/O user device 130 are now described. The first I/O user device 130 can include at least one processor 1100 (FIG. 7), and\at least one memory 1110 (FIG. 7) storing program code that is executable by the at least one processor to perform operations. The operations include to receive 502 from a user tag an attach request, and forward 503 the attach request to an authenticator 400. The operations forward 504 to the user tag an identity request received from the authenticator 400, and forward 505 to the authenticator 400 a response received from the user tag, the response which contains an identifier of the user tag containing an address of a user terminal emulation application 110 hosted by a user terminal emulation server 100. The operations receive 510 from the authenticator 400 a message comprising a first I/O user device specific key for the first I/O user device 130, a session identifier, and the address for the user terminal emulation application 110. The operations establish 511 a secure channel connection with the user terminal emulation application 110 using the first I/O user device specific key and the session identifier received from the authenticator 400. The operations send 512 an indication of an I/O user interface capability of the first I/O user device to the user terminal emulation application 110 through the secure channel connection. The operations communicate 512 with the user terminal emulation server 100 to use the I/O user interface capability of the first I/O user device 130 to provide at least part of a communication service to a user.

The operation to establish 511 the secure channel connection with the user terminal emulation application 110 using the first I/O user device specific key and the session identifier received from the authenticator 400, may include sending the session identifier and an identifier of the first I/O user device to the user terminal emulation application 110 to indicate which I/O user device specific key is to be used to establish 511 the secure channel connection.

The first I/O user device 130 may include a near-field communication, NFC, reader circuit configured to power the user tag to send 502 the attach request.

Utilizing authorization tokens and related operations are now discussed below.

In operations 508 above, when the user tag 101 has authenticated itself towards the EAP server/user terminal emulation application 110 using EAP, the user tag 101 now also possesses the session keying material. Using this, the user tag 101 may generate authorization tokens for other IODs, e.g., IOD X, that the user tag 101 wants to add to the currently ongoing session.

These operations may be an alternative to having the EAP Authenticator 400 or the IODH 212 delegate session keys to the I/O user devices. The token may, e.g., be a signed piece of data contain things such as the session ID (so that the EAP server/user terminal emulation application 110 can map the token to the session), the newly selected I/O user devices identity (so that EAP server/user terminal emulation application 110 can verify that the correct I/O user device is using the token) and possible a lifetime of the token.

The user tag 101 may provide such token (and a pointer to the EAP server/user terminal emulation application 110) to selected I/O user devices, which could then connect to the EAP server/user terminal emulation application 110 and present the token as proof of authorization by the user tag 101. The communication between user tag 101 and newly selected I/O user device may be similar to the initial registration to the IOD Domain 410 as described above starting with operation 501; the user tag 101 indicates it wants to connect the I/O user device IOD X to the EAP server/user terminal emulation application 110, but in a way that the I/O user device IOD X understands to reply with its identity.

As an example, when providing the user tag's identity in the EAP identity reply message, the user tag 101 may use the session ID as an identifier (or part of the identifier). The I/O user device IOD X itself, or the EAP Authenticator 400 may determine from the identifier a relation to an already ongoing session and which would result in providing the user tag 101 with the identity of the new I/O user device.

The identity of the I/O user device may be interpreted as an authentication challenge in an EAP method. The reply to the challenge may be the token generated by the user tag 101. The I/O user device IOD X may use the help of the EAP Authenticator 400 to verify that the token is valid (e.g., the EAP Authenticator 400 possesses the same keying material and can verify the signature), or may blindly trust the token and start using it towards the EAP server/user terminal emulation application 110.

These operations provide the user tag 101 and/or the user more control with respect to which I/O user device(s) are connected to the session as the user needs to select the used I/O user device(s). For proper trust in the tag by the EAP server/user terminal emulation application 110, the user tag 101 would also have a signature generated by the permanent credential of the user tag 101 towards the EAP server/user terminal emulation application 110 (or non-exported keying material of the EAP exchange, i.e. keying material not shared with the EAP Authenticator 400), since the EAP generated session key is also known to the EAP Authenticator 400, which therefor could generate a valid looking token even without the knowledge of the user.

Public vs private IOD domains and related operations are now discussed below.

The operations described above may be used in various scenarios such as in public locations (e.g., vacation resort/hotel) or private locations (e.g. enterprise office/complex). For these different types of scenarios there are differences with respect to access control requirements, such as for a public location (typically) anyone should be able to connect their cloud service (e.g., user terminal emulation application 110) to a public I/O user device, while in a private setting only authorized services/users would typically be allowed. This could be, e.g., the employees of a company being allowed to connect their user terminal emulation application 110 to I/O user devices in the office building. Alternatively, a mixed model may be provided where certain I/O user devices are accessible to anyone, while some other I/O user devices are only accessible to a subset of users and/or user terminal emulation applications 110.

Controller function and related operations are now discussed below.

A controller function in the IOD Domain 410 may be responsible for verifying that the connecting user terminal emulation application 110 is authorized to connect to the specified I/O user device. This could be a separate entity or a function of the IODH 212, which knows about all the I/O user devices in the domain 410. Alternatively, the controller function may be a part of the EAP Authenticator 400 or an Authentication and Key Management for Applications (AKMA) server, respectively (which in turn may be part of IODH 212, or be separate entities/functions).

When a user terminal emulation applications 110 or user is being authenticated to an AKMA server or the EAP Authenticator 400, the I/O user device Domain controller (IDC) can operate to verify that the connecting identity (tag identity authenticated with EAP, user terminal emulation applications identity learnt during EAP while setting up secure channel to user terminal emulation applications 110, or user terminal emulation applications identity learnt during AKMA authentication) is authorized to access services in the IOD Domain 410, and the target I/O user device specifically. If there are access control policies which indicate that the user and/or user terminal emulation applications 110 is not allowed, the controller function can operate to terminate the authentication and may provide some error code indicating the user and/or service is not authorized.

3GPP Key agreement method and related operations are now discussed below.

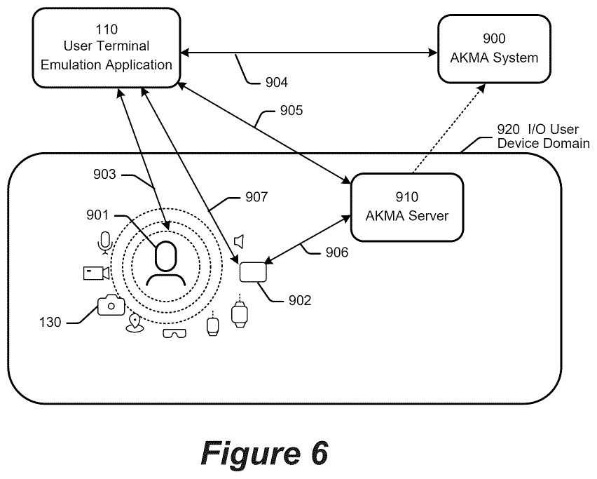

A 3GPP key agreement function for providing a communication service through a user terminal emulation application to I/O user devices in an I/O user device domain 920 is now described. Various operations are described in the context of AKMA and GBA, but are not limited thereto. FIG. 6 illustrates a combined flowchart of operations and related data flows between a user tag, I/O user devices, a 3GPP key agreement function system (which may be an AKMA system or Generic Bootstrapping Architecture system), and a user terminal emulation server 110 in accordance with some embodiments of the present disclosure. FIG. 10 illustrates a flowchart of operations that may be performed by the user terminal emulation server 110 in accordance with some embodiments.

Referring to FIG. 6, a user 901 selects a target I/O user device 902 and obtains therefrom an I/O user device identifier. For example, the user may scan an I/O user device identifier, such as by scanning a QR code, reading an identifier from a sticker on the I/O user device and entering the identifier into the user's own input device, using NFC to read the identifier from the I/O user device, etc. The user tag and I/O user device may include circuitry configured to utilize one or more communication protocols to communicate information described herein The I/O user device identifier can include an identifier of the I/O user device (IOD_ID) and an IOD Domain identifier, e.g. screen123@myioddomain.com.

The user 901 connects 903 to and authenticates to user terminal emulation application 110 (own cloud-based service). The I/O user device, or IOD Domain, may provide communication connectivity, e.g., over Bluetooth, WiFi, NFC, etc. or the user device and/or user tag may be configured with its own communication connectivity. Once the user terminal emulation application 110 has authenticated user/tag, the user 901 provides the obtained IOD ID to user terminal emulation application 110.

The user terminal emulation application 110 generates mobile subscription/SIM based credentials for use towards services by interacting 904 with the AKMA system 900 or a Generic Bootstrapping Architecture (GBA) function in the mobile operator. A result of the interacting 904 is that the user terminal emulation application 110 and the mobile operator, e.g., AKMA or GBA function, has a shared master AKMA secret key or shared master GBA secret key, and has an identifier for the context or key.

The user terminal emulation application 110 connects to the IOD Domain (e.g., AKMA Server) based on the I/O user device identifier (received in operation 903) realm part (e.g., myioddomain.com). The user terminal emulation application 110 derives an IOD Domain (e.g., AKMA Server 910) specific key from the AKMA or GBA master secret key. The user terminal emulation application 110 provides the AKMA or GBA context identifier to IOD Domain (e.g., AKMA Server 910). The IOD Domain (e.g., AKMA Server 910) uses the received AKMA or GBA context identifier to obtain IOD Domain specific AKMA or GBA key from the mobile operator AKMA or GBA function (e.g., AKMA Server 910), which may require pre-existing SLA/trust relationship between the IOD Domain and the mobile operator hosting the AKMA System. The user terminal emulation application 110 and the IOD Domain (e.g., AKMA Server 910) authenticate using the IOD Domain specific AKMA or GBA key, which may use a created secure session for further communication.

The user terminal emulation application 110 tells 905 the IOD Domain which I/O user device (e.g., screen123) it wants to interact with, e.g., based on the I/O user device identifier received in operation 903. The user terminal emulation application 110 also provides a pointer to itself, e.g., IP address, FQDN, etc.

The IOD Domain 920 (e.g., AKMA Server 910) generates 906 an IOD specific AKMA or GBA session key from the IOD Domain specific AKMA or GBA key and the I/O user device identity, which may be similar to how in the EAP example above an IOD specific key is derived from EAP PMK and provides the IOD specific key to the I/O user device. The IOD Domain 920 (e.g., AKMA Server 910) may also provide a pointer to the user terminal emulation application 110, and an AKMA or GBA context identifier.

The I/O user device connects 907 to the user terminal emulation application 110 based on received info. The I/O user device indicates the AKMA or GBA context identifier to the user terminal emulation application 110. The user terminal emulation application 110 can locate the AKMA or GBA context (e.g., AKMA or GBA master key). The I/O user device indicates its identity to the user terminal emulation application 110. The user terminal emulation application 110 can use the I/O user device identity together with the IOD Domain specific AKMA or GBA key to derive IOD specific AKMA or GBA session key. The user terminal emulation application 110 and the I/O user device can mutually authenticate using the I/O user device specific AKMA or GBA session key. The user terminal emulation application 110 and the I/O user device can use key to further establish a secure channel between themselves for streaming data for the communication service.

The operations by the user terminal emulation server 100 may more generally include, with reference to FIG. 9, to authenticate 903 an identifier of the user tag or a user, receive 903 the identifier of the first I/O user device. The operations generate 904 and 905 the first I/O user device specific key through communications with a 3GPP key agreement function.

The key agreement function may include one of: an AKMA function; a GBA function; and a Battery Efficient Security for very low Throughput Machine Type Communication function.

The operation to generate 904 and 905 the first I/O user device specific key through communication with the key agreement function, may include to generate the first I/O user device specific key based on processing the master key derived through the key agreement function.

The operations may further include to communicate with the 3GPP key agreement function, e.g., AKMA function, hosted in a mobile operator system to generate a shared secret between the user terminal emulation server 100 and the key agreement function.

Example I/O user device, user terminal emulation server, EAP authenticator or AKMA server, user tag, and mobility manager are now discussed below.

FIG. 7 is a block diagram of hardware circuit components of an I/O user device 130 which are configured to operate in accordance with some embodiments. The I/O user device 130 can include a wired/wireless network interface circuit 1102, a near field communication circuit 1120, at least one processor circuit 1100 (processor), and at least one memory circuit 1110 (memory). The processor 1100 is connected to communicate with the other components. The memory 1110 stores program code (e.g., user terminal emulation application(s) 110) that is executed by the processor 1100 to perform operations disclosed herein. The processor 1100 may include one or more data processing circuits (e.g., microprocessor and/or digital signal processor), which may be collocated or distributed across one or more data networks. The processor 1100 is configured to execute the program code in the memory 1110, described below as a non-transitory computer readable medium, to perform some or all of the operations and methods for one or more of the embodiments disclosed herein for a mobile electronic device. The I/O user device 130 can include one or more UI component devices, including without limitation, a microphone 1140, a speaker 1150, a camera 1130, a display device 1160, and a user input interface 1170.

FIG. 8 is a block diagram of hardware circuit components of a user terminal emulation server 100 which are configured to operate in accordance with some embodiments. The user terminal emulation server 100 can include a wired/wireless network interface circuit 1250, a database 120 (e.g., any one or more of a listing I/O user devices, UI capabilities of the I/O user devices, communication protocols used to communicate with the I/O user devices, known proximities to user identifiers, identifiers of user tags, I/O user device specific keys, session identifiers, etc.), a display device 1230, a user input interface 1240 (e.g., keyboard or touch sensitive display), at least one processor circuit 1200 (processor), and at least one memory circuit 1220 (memory). The processor 1200 is connected to communicate with the other components. The memory 1220 stores user terminal emulation application(s) 110 that is executed by the processor 1200 to perform operations disclosed herein. The processor 1200 may include one or more data processing circuits (e.g., microprocessor and/or digital signal processor), which may be collocated or distributed across one or more data networks. The processor 1200 is configured to execute computer program instructions in the memory 1220, described below as a non-transitory computer readable medium, to perform some or all of the operations and methods for one or more of the embodiments disclosed herein for a mobile electronic device.

FIG. 9 illustrates a block diagram of hardware circuit components of an EAP authenticator 400 or AKMA server 910 that are configured to operate in accordance with some embodiments of the present disclosure. The components can include a wired/wireless network interface circuit 950, a display device 960, a user input interface 970 (e.g., keyboard or touch sensitive display), at least one processor circuit 930 (processor), and at least one memory circuit 940 (memory). The processor 930 is connected to communicate with the other components. The memory 940 stores program instructions that are executed by the processor 930 to perform operations disclosed herein. The processor 930 may include one or more data processing circuits (e.g., microprocessor and/or digital signal processor), which may be collocated or distributed across one or more data networks. The processor 930 is configured to execute computer program instructions in the memory 940, described below as a non-transitory computer readable medium, to perform some or all of the operations and methods for one or more of the embodiments disclosed herein for a mobile electronic device.

FIG. 10 illustrates a block diagram of hardware circuit components of a user tag 101 that are configured to operate in accordance with some embodiments of the present disclosure. The components can include a wired/wireless network interface circuit 1050, a display device 1030, a user input interface 1040 (e.g., keyboard or touch sensitive display), at least one processor circuit 1000 (processor), and at least one memory circuit 1020 (memory). The processor 1000 is connected to communicate with the other components. The memory 1020 stores program instructions that are executed by the processor 1000 to perform operations disclosed herein. The processor 1000 may include one or more data processing circuits (e.g., microprocessor and/or digital signal processor), which may be collocated or distributed across one or more data networks. The processor 1000 is configured to execute computer program instructions in the memory 1020, described below as a non-transitory computer readable medium, to perform some or all of the operations and methods for one or more of the embodiments disclosed herein for a mobile electronic device.

Systems and operations for managing mobility of communication services across I/O user devices are now discussed below.

Some further embodiments of the present disclosure are directed to provide a mobility manager which is responsible for managing mobility of communication services across I/O user devices responsive to mobility of user tags transported by users and/or the I/O user devices.

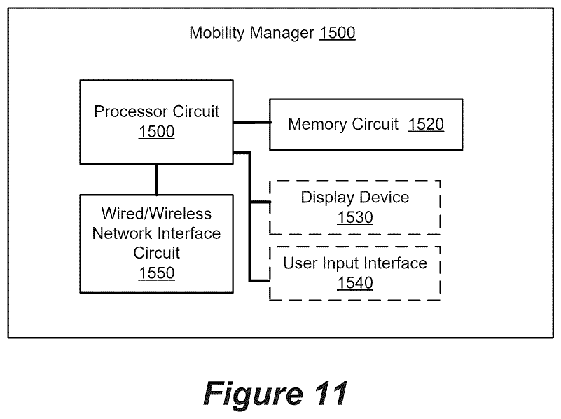

FIG. 11 illustrates a block diagram of hardware circuit components of a mobility manager 1260 that are configured to operate in accordance with some embodiments of the present disclosure. The components can include a wired/wireless network interface circuit 1150, a display device 1130, a user input interface 1140 (e.g., keyboard or touch sensitive display), at least one processor circuit 1100 (processor), and at least one memory circuit 1120 (memory). Although components of the mobility manager 1260 are illustrated separately from components of the user terminal emulation server 100, some or all of the functionality of the mobility manager 1260 may be incorporated into the user terminal emulation server 100. The processor 1100 is connected to communicate with the other components. The memory 1120 stores program instructions that are executed by the processor 1100 to perform operations disclosed herein. The processor 1100 may include one or more data processing circuits (e.g., microprocessor and/or digital signal processor), which may be collocated or distributed across one or more data networks. The processor 1100 is configured to execute computer program instructions in the memory 1120, described below as a non-transitory computer readable medium, to perform some or all of the operations and methods for one or more of the embodiments disclosed herein for a mobile electronic device.

Before discussing details of mobility management in accordance with some embodiments of the present disclosure, an overview of 3GPP based mobility management and related Bluetooth and WiFi headset mobility are discussed.

Example 3GPP mobility management can include the following operations.

Event A3 is triggered when a neighbor cell becomes better than a special cell (SpCell) by an offset. A special cell is the primary serving cell of either the Master Cell Group (MCG) or Secondary Cell Group (SCG)). The offset can be either positive or negative. Measurement report management for LTE is described in Section 5.5 of 3GPP TS 36.331 Release 17, V17.1.0. Measurement report management for NR is described in Section 5.5 of 3GPP TS 38.331 Release 17, V17.1.0.

This event is typically used for intra-frequency or inter-frequency handover procedures. When Event A2 is triggered, the UE may be configured with measurement gaps to measure the inter-frequency objects and Event A3 for inter-frequency handover. Event A3 provides a handover triggering mechanism based upon relative measurement results, e.g., it can be configured to trigger when the Reference Signal Received Power (RSRP) of a neighbor cell is stronger than the RSRP of serving cell.

Trigger and cancel condition according to:

$$\begin{matrix}Mn + Ofn + Ocn - Hys > Mp + Ofp + Ocp + Off & ( trigger condition ) \\ Mn + Ofn + Ocn + Hys < Mp + Ofp + Ocp + Off & ( cancellation condition )\end{matrix}$$

For example, consider A3-offset is set to as 3 dB, hys, Ofn, Ofp and Ocp are set to 0 dB. As soon as UE found any neighbor cell whose measurements is 3 dB better than serving cell, it should report the Event A3; e.g. Neighbor cell RSRP=−78 dBm and Serving cell RSRP=−82 dBm, here neighbor cell is better and satisfy the Event offset, so UE will report Event A3 to the gNB.

In the above trigger condition and cancellation condition, the terms have the following meanings:
Mn is the measurement result of the neighboring cell, not taking into account any offsets.
Ofn is the measurement object specific offset of the reference signal of the neighbour cell i.e. offsetMO as defined within measObjectNR corresponding to the neighbour cell).
Ocn is the cell specific offset of the neighbor cell i.e. cellIndividualOffset as defined within measObjectNR corresponding to the frequency of the neighbor cell, and set to zero if not configured for the neighbor cell.
Mp is the measurement result of the SpCell, not taking into account any offsets.
Ofp is the measurement object specific offset of the SpCell i.e. offsetMO as defined within measObjectNR corresponding to the SpCell.
Ocp is the cell specific offset of the SpCell i.e. cellIndividualOffset as defined within measObjectNR corresponding to the SpCell, and is set to zero if not configured for the SpCell.
Hys is the hysteresis parameter for this event i.e. hysteresis as defined within reportConfigNR.
Off is the offset parameter for this event i.e. a3-Offset as defined within reportConfigNR.
Mn, Mp are expressed in dBm in case of RSRP, or in dB in case of RSRQ and RS-SINR

Related uplink-based handover procedures can include the following operations.

Many approaches have been provided in previous evolvements of mobile systems. There are several explanations why downlink reference symbol-based solutions where adopted, where amongst others where the historical lack high-capacity BS-BS and later on NodeB-NodeB and later on eNB-eNB fiber connection that would have enabled joint uplink “base station” reception. Although today's solutions have gigabit gNB-gNB connections, as systems “must have” backwards compatibility, these approaches are challenged by the downlink-based approach.

One rather recent suggestion porting LTE to UE-transmitted UL SRS-based mobility, includes where the UE transmits UL RSs which are received at the serving and, possibly, several neighboring BSs (n-BSs), allowing the network to perform UL signal strength measurements. These measurements are processed in a central network controller to make intelligent proactive decisions on which BS shall serve a given user. The realization of the UL-HO scheme comes with the requirement that the time synchronization between the BSs receiving the UL RS should be within some specified upper bound.

This requirement may already be in place to efficiently support other implementations such as TDD operation, joint uplink transmission, etc. in small cell deployments with very short propagation times. In addition, in order for a n-BSs to be able configuration parameters (timing, frequency, code, etc.) of such UL RS, which are set by the s-BS, are also shared with n-BS. This can be effectively achieved via existing interfaces (such as e.g., X2 or S1 in LTE) and would only require some minor standard upgrades in defining the information elements to be communicated between the BSs.

From a power control perspective, note that there is only a need for n-BSs to detect and measure the UL RS when the UE is approaching the cell border, i.e., where handovers take place. When this happens, the power control set by the s-BS should allow the UL RS to be received at the n-BS, since both the s-BS and n-BS become almost equidistant (in radio terms that is).

Furthermore, the detection of UL RS is rather robust since it is, by design, a known signal transmission, with known time, frequency, and code signatures and thus readily detectable and measurable at the n-BSs. The rest of the handover (HO) procedure remains the same as in LTE and NR starting from the HO preparation phase. By reusing the UL channel measurements from UL RSs (needed in, e.g., massive MIMO operation) also for mobility purposes requires no extra signaling overhead. Another benefit of using UL measurements for UE mobility is that it is possible to improve the network performance by network side upgrades without UE impact.

The network controller measurement processing can include where, as UE moves through the network, the serving BS becomes weaker than the target BS. The serving, as well as n-BSs to detect and measure the UL RS, it is also required that the perform UL RS received power (UL-RSRP) measurements and these measurements are processed in a central network controller. If the UL-RSRP of the serving BS is less than a target BS by an offset called “A3 UL-offset”, and this condition is maintained during the time defined by “UL Time To Trigger (UL-TTT)”, the controller decides which BS shall serve the given UE. Based on the controller HO decision, the serving BS sends a HO request to the controller suggested target BS.

Example Bluetooth and WiFi headset mobility management can include the following operations.

Wi-Fi access point mobility is typically device centric where a (proprietary, chipset specific) algorithm detects channel signal strength (quality) and evaluates if channel provided from one access point at some channel (e.g. 1,6,11 as orthogonal for 801.22b/g) provides better signal strength than some other access point. If that case is determined, device has to cease connection for the pre access point (i.e., halt application data flow) and resume communication at the new access point after legacy steps of authentication, association and handshake.

There are managed solutions where network controller node(s) in more cellular manner supports selections, packer forwarding and Wi-Fi node groupings.

Wi-Fi mobility is downlink central where access points transmit beacon signals for devices to measure and determine mobility based on

Some problems that may arise if 3GPP, Bluetooth, or WiFi mobility management were to be attempted to be extended to the system architectures of FIGS. 1-6 are now described.

3GPP mechanisms cannot address experienced mobility challenge since they all are based on e/gNB transmitted downlink reference symbol detection measured and evaluated by a UE and reported to a serving UE-e/gNB.

3GPP solutions also only addresses scenarios where a UE moves between different e/gNBs, not that a non-3GPP user-defining minimalistic device (user tag 101) e.g., operating over NFC, active/passive RFID or Bluetooth, etc., is moving between communicating with different UEs (I/O user devices 130).

Control-data plane termination in legacy solutions terminates in UE, whereas in the architecture of FIGS. 1-6 the control plane terminates in the user tag and the data plane terminates in associated I/O user devices 130.

Prior mechanisms do not manage mobility based on providing certain UI capability among the I/O user device(s) 130 used for a communication service to be provided or being provided to a user, and attempting to maintain continuity in the UI capability when performing handover between I/O user devices 130. For example, the disaggregated paradigm provided by current e/gNB-centric solutions cannot manage the UI capability (media type) and provide UI continuity for a communication service.

Various embodiments of the present disclosure are directed to operations by a mobility manager that manages mobility of a user tag in communications with I/O user devices with respect to the user's relative (e.g., radio measure-based) locality and current user status (e.g., idle/active communications state), and in the latter selecting and managing session media mobility. The mobility manager can be responsible for processing content of user tag beacon signal data, beacon signal filtering, beacon signal strength/threshold evaluations, and responsive application of mobility procedures.

In prior mobility paradigms, UE mobility is managed between e/gNBs where: reference signals are sent either by e/gNB (DL) or UE (SRS, UL); mobility principles are executed by e/gNB or a radio network control node; and the involved user (data) plane and control plane both terminates in the UE. In contrast to these prior mobility paradigms, operations according to various present embodiments involve: control plane terminating in the user tag; user (data) plane terminating in any of the I/O user devices which in their role simultaneously act as reception point for user tag beacon signals, and where mobility of the user tag between the I/O user devices can be managed by a central mobility manager based on attributes of a user tag beacon signal detected by multiple I/O user devices.

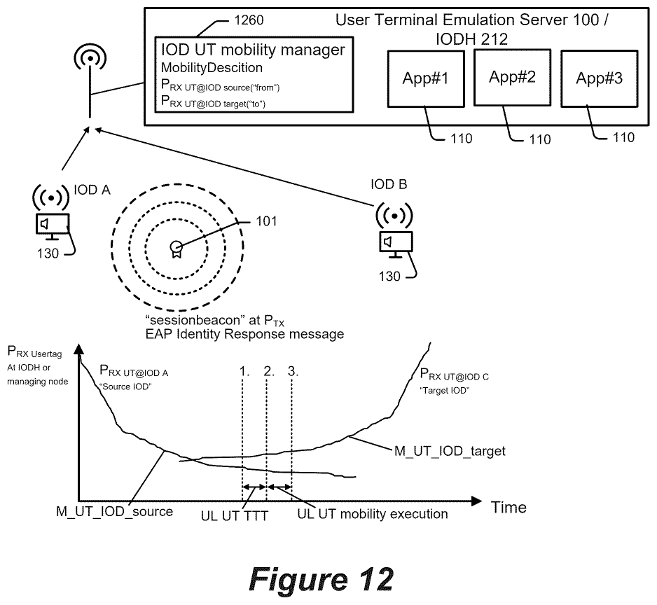

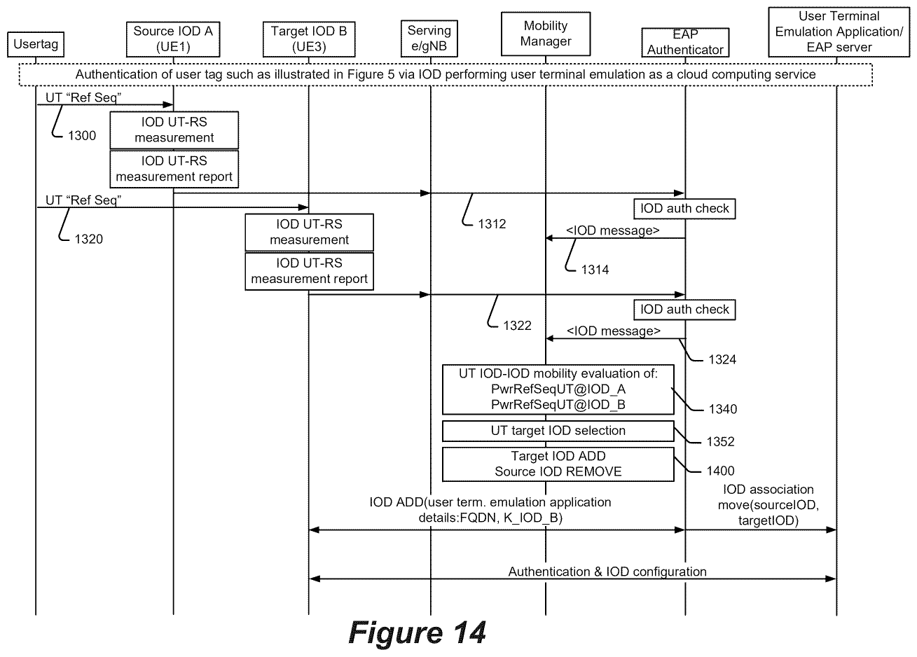

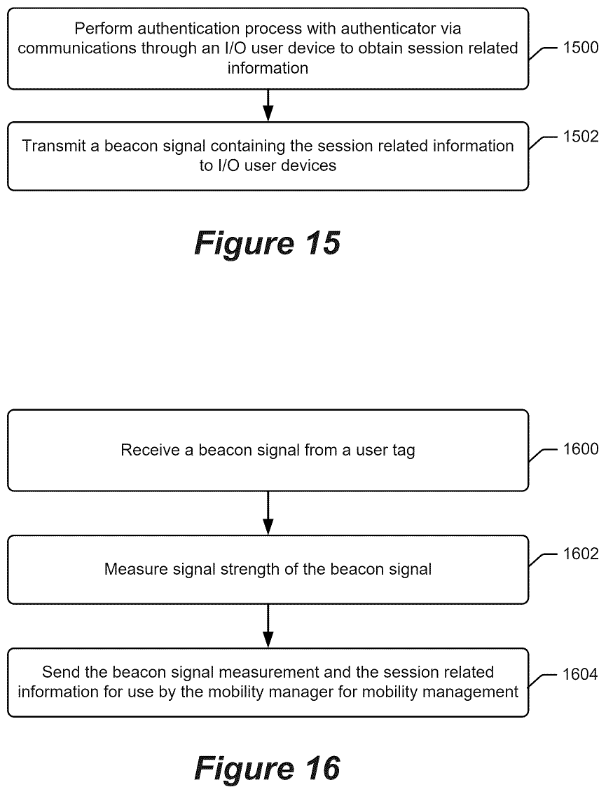

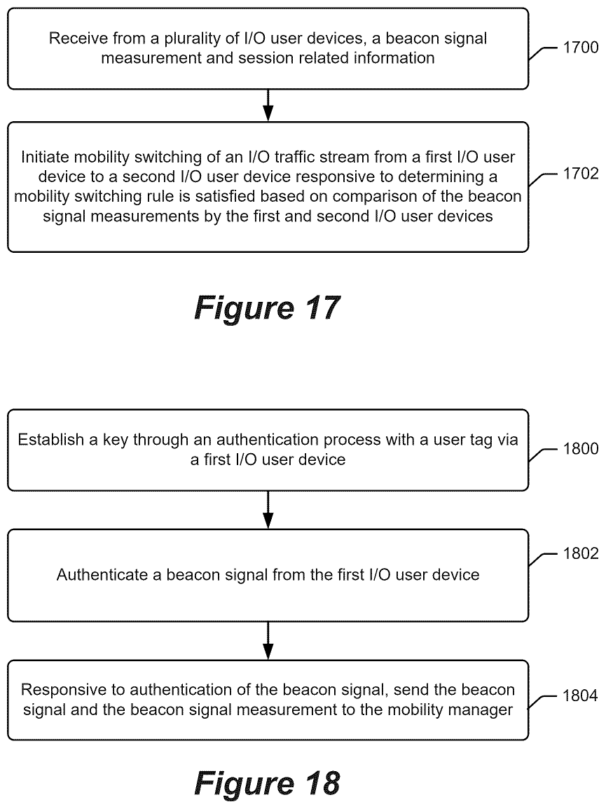

Some mobility management operations are now described in the context of a scenario where a user tag (UT) transmits a beacon signal containing session related information which is received by two I/O user devices (IOD A and IOD B) which are proximately located to the user tag (UT). FIG. 12 illustrates a mobility scenario and some related mobility management operations that can be performed by a mobility manager in accordance with some embodiments of the present disclosure. FIG. 15 illustrates a flowchart of operations that can be performed by a user tag in accordance with some embodiments of the present disclosure. FIG. 16 illustrates a flowchart of operations that can be performed by an I/O user device in accordance with some embodiments of the present disclosure. FIG. 17 illustrates a flowchart of operations that can be performed by a mobility manager in accordance with some embodiments of the present disclosure.

Referring to FIGS. 12, 15, 16, and 17, the example user terminal emulation server and IODH 100 has three user terminal emulation applications 110, illustrated as App #1, App #2, App #3, which have been invoked and are being execution by the server 100. Usertag 101 is transportable by a user and includes circuitry configured to perform an authentication process 1100 with an authenticator 400 (FIG. 4) or 910 (FIG. 6) via communications through an I/O user device IOD A 130 or IOD B 130 to obtain session related information. The Usertag 101 transmits 1502 a beacon signal containing the session related information to I/O user devices proximately located to the Usertag 101.

In some further embodiments, the user tag circuitry may be configured to obtain the session related information based on an authenticated session identifier obtained through communications with the authenticator 400 for authentication. For example, the user tag circuitry may obtain the session related information from an EAP response message from the authenticator. The user tag circuitry may be configured to receive beacon configuration information from the I/O user device 130, and to transmit the beacon signal at an interval defined based on the beacon configuration information. The user tag circuitry may be configured to receive beacon configuration information from the I/O user device 130, and to transmit the beacon signal at a power level defined based on the beacon configuration information. As will be described in further detail below, the user tag circuitry may be configured to derive a key based on the authentication process with the authenticator 400, and to transmit the beacon signal with secure communications protection using the key. These and other related embodiments of user tag operations are described in further detail below.

IOD A 130 and IOD B 130 are spaced apart in location and receive 1600 the beacon signal transmitted by the Usertag 101, and each separately measures 1602 signal strength of the beacon signal to generate a beacon signal measurement. IOD A 130 and IOD B 130 each send 1604 the beacon signal measurement and the session related information for use by the mobility manager 1260 for mobility management of a communication service for the user that can be provided by the user terminal emulation server 100 and/or IODH 212. As explained below, the mobility manager 1260 can use the beacon signal measurements to manage mobility of a communication service for one or more of the user terminal emulation applications 110, (App #1, App #2, App #3), such as by triggering switching of a communication stream that was being routed to IOD A 130 to instead being routed to IOD B 130.

In the illustrated scenario, a Usertag uplink IOD-to-IOD event is determined by the mobility manager 1260 to occur at time event “1”, illustrated in the graph of received power (PRX Usertag) versus time, based on the reported beacon signal measurements. In the illustrated graph, the beacon signal measurement by IOD A becomes a defined threshold (e.g., X dB) weaker than the beacon signal measurement by IOD B, which triggers handover. The operations may include use of a hysteresis threshold to avoid unnecessary ping-pong switching back-and-forth, threshold offsets defining a level of signal strength improvement that needs to be observed before triggering a switch, and filtering (e.g., smoothing) that can be applied over time to a series of beacon signal measurements received from each of the IODs.

The illustrated subsequent time event “2” corresponds to a UserTag IOD-IOD mobility evaluation Time-to-Trigger (TTT), which is after expiration of TTT the mobility manager 1260 determines what IOD-to-IOD mobility is to be executed.

The further illustrated subsequent time event “3” corresponds to the mobility manager 1260 initiating IOD A to IOD B mobility. The mobility manager 1260 carries out authentication and IOD stream configuration, IOD B stream ADD (e.g., adding user terminal emulation application details: FQDN, K_IOD_B) to initiate routing of a media stream to IOD B, and IOD A stream REMOVE to initiate ceasing of routing of the media steam to IOD A. The ADD decision may be performed by the mobility manager 1260, but the execution of the ADD event can optionally or typically flow through the EAP authenticator, and possibly signaled via the IODH 212. For example, the mobility manager 1260 may request the EAP authenticator, or request the IODH 212 which requests the EAP authenticator, to add the IOD stream. It is noted that these operations can correspond to mobility handover, although other remove actions may be subject to IOD-handover, e.g., when a new IOD with required UI capability (ies) is detected. In such case, a longer hysteresis to remove IOD A or discontinue the media stream may be needed. It is also noted that initiating routing of the media stream to IOD B (i.e., handover IOD) may be delayed until the user is determined to be proximately located to IOD B, such as responsive to a camera of IOD B or another local IOD identifying presence of the user transporting Usertag 101.

In some further embodiments, the I/O user device (IOD) circuitry may be configured to directly or indirectly receive from the mobility manager 1260 a message containing an instruction to add an I/O traffic stream associated with the session related information, and to initiate outputting and/or inputting through at least one I/O user interface of the I/O user device 130 content of the I/O traffic stream associated with the session related information between the I/O user device 130 and a user terminal emulation application 110. The IOD circuitry may be configured to receive from the mobility manager 1260 a message containing an instruction to remove an I/O traffic stream associated with the session related information, and to cease outputting and/or inputting through at least one I/O user interface of the I/O user device 130 content of the I/O traffic stream associated with the session related information between the I/O user device 130 and a user terminal emulation application 110. The IOD circuitry may be configured to generate the beacon signal measurement based on a present measurement of signal strength of the beacon signal presently received from the user tag combined with at least one previous measurement of signal strength of at least one previously received beacon signal from the user tag. The combining of previous measurements of signal strength may include filtering as discussed below.

In some further embodiments, the operation by the IOD circuitry to send 1604 the beacon signal measurement and the session related information to the mobility manager 1260 for mobility management, may include sending the beacon signal measurement for use by the mobility manager 1260 at a periodic interval of length to receive a plurality of beacon signals from the user tag for use in generating the beacon signal measurement based on combining the measurements of signal strength of the plurality of beacon signals. The IOD circuitry may be further configured to trigger sending of the beacon signal measurement for use by the mobility manager 1260 responsive to at least a threshold change in measurements of signal strength over a sequence of received beacon signals.

These and other related embodiments of IOD operations are described in further detail below.

According to some embodiments, mobility management operation can differ depending upon whether mobility is being performed for idle versus active user sessions. In an idle session, the user has no active data streams to and from a User Terminal Emulation Application 110 and/or authenticator 400 (FIG. 4) or 910 (FIG. 6) to consider, although the mobility manager 1260 can operate to keep track of location and beacon signal measurements for the user tag 101.

The mobility manager 1260 for managing mobility of the communication service for a user through IOD A and IOD B (I/O user devices 130), can include circuitry configured to receive 1700 from IOD A and IOD B, the beacon signal measurement and session related information. As explained above, the beacon signal measurement indicates a signal strength measurement by the IOD (IOD A or IOD B) of a beacon signal from the user tag 101. The mobility manager 1260 initiates 1702 mobility switching of an I/O traffic stream associated with the session related information from being routed between a user terminal emulation application 110 hosted by the user terminal emulation server 100 and IOD A to being routed between the user terminal emulation application 110 and IOD B, responsive to determining a mobility switching rule is satisfied based on comparison of the beacon signal measurements by the IOD A and IOD B.

In some further embodiments, the mobility manager circuitry may be configured to determine 1702 the mobility switching rule is satisfied for switching the I/O traffic stream to the second I/O user device 130 based on determining a user interface (UI) capability of the second I/O user device 130 is operational for providing the communication service, and based on the comparison of the beacon signal measurements by the first I/O user device 130 and the second I/O user device 130. The mobility manager circuitry may be configured to further determine 1702 the mobility switching rule is satisfied for switching the I/O traffic stream to the second I/O user device 130 based on measurements of radio channel quality between a radio access network 220 and the first and second I/O user devices 130. Alternatively or additionally, the mobility switching rule may be satisfied for switching based on measurements of link status, such as whether the link is congested resulting in insufficient bitrate and/or excessive latency, and comparison of link statuses between links of the first and second I/O user devices.

The mobility manager circuitry may be configured to determine 1702 the mobility switching rule is satisfied for switching the I/O traffic stream to the second I/O user device 130 based on determining the UI capability of the second I/O user device 130 is combinable with a UI capability of a third I/O user device 130 to satisfy a combined UI capability operational required for providing the communication service, and based on the beacon signal measurements by the first I/O user device 130, the second I/O user device 130, and the third I/O user device 130. The mobility manager circuitry may be configured to determine 1702 the mobility switching rule is satisfied for switching the I/O traffic stream to the second I/O user device 130 based on determining that a result of summation of the beacon signal measurement by the second I/O user device 130 and a second offset threshold exceeds a result of summation of the beacon signal measurement by the first I/O user device 130 and a first offset threshold. The mobility manager circuitry may be configured to, based on determining the beacon signal measurement by a third I/O user device satisfies a database addition rule, updating a database 120 to add the beacon signal measurement and the session related information of the third I/O user device to be associated with an indication of a user UI capability of the third I/O user device, wherein the database 120 identifies network addresses of I/O user devices and UI capabilities of the I/O user devices that are candidates for use in providing the communication service to the user.

The mobility manager circuitry may be configured to initiate 1702 mobility switching of the I/O traffic stream by operations that include sending to the second I/O user device 130 a message containing an instruction to add the I/O traffic stream associated with the session related information, and sending to the first I/O user device 130 a message containing an instruction to remove the I/O traffic stream associated with the session related information.

The mobility manager circuitry may be configured to receive the beacon signal measurement and the session related information for one of the I/O user devices 130 in a message that is sent by an authenticator 400 responsive to the authenticator 400 receiving and successfully authenticating content of the message from the one of the I/O user devices 130. The mobility manager circuitry may be configured to receive the beacon signal measurement and the session related information in a message sent by one of the I/O user devices 130, and to authenticate content of the message based on a key obtained from an authenticator 400.

The mobility manager circuitry may be configured to, for each of the I/O user devices, generate a filtered beacon signal measurement based on combining a newly received beacon signal measurement with at least one previous beacon signal measurement, and to initiate the mobility switching of the I/O traffic stream associated with the session related information from being routed between the user terminal emulation application 110 hosted by the user terminal emulation server 100 and the first I/O user device 130 to being routed between the user terminal emulation application 110 and the second I/O user device 130, responsive to determining a mobility switching rule is satisfied based on comparison of the filtered beacon signal measurement of the first I/O user device 130 and the filtered beacon signal measurement of the second I/O user device 130.

These and other related embodiments of mobility manager operations are described in further detail below.

Various more general operations by the authenticator are now described with reference to FIG. 18. As explained above for some embodiments, communications between the user tag 101 and the user terminal emulation application 110 can be routed through the EAP authenticator 400 for authentication. The user tag 101 and the user terminal emulation application 110 can share a first key. The user terminal emulation application 110 provides a second key to the EAP authenticator 400, and the user tag 101 locally derives from the first key the same second key. From the second key, the user tag 101 and the EAP authenticator 400 derive (e.g., among other keys) a third key (also referred to as a user tag specific key), which the user tag 101 uses to protect the beacon signal it transmits. The EAP authenticator 400 (or IODH 212 if the third key is shared to the IODH 212) verifies the beacon signal using the third key, where the beacon signal is measured by the I/O user device. The authentication protocol between the user tag 101 and the user terminal emulation application 110 is communicated through the I/O user device acting as an access point, but the I/O user device is not, in at least some embodiments, involved in the authentication process.

Referring to FIG. 18, the authenticator 400 includes circuitry configured to establish 1800 a key through an authentication process with the user tag 101 via a first I/O user device (e.g., IOD A). The authenticator 400 authenticates 1802 a beacon signal from the first I/O user device (IOD A) based on the key. The beacon signal is accompanied by a beacon signal measurement that indicates a signal strength measurement by the first I/O user device (IOD A) of the beacon signal from a user tag transportable by the user. The beacon signal is secured using the key. Responsive to authentication of the beacon signal, the authenticator 400 sends 1804 the beacon signal (at least part of the beacon signal) and the beacon signal measurement to the mobility manager 1260 managing mobility of a communication service for a user through the IOD A and IOD B and/or other I/O user devices 130. The sending 1804 of the beacon signal by the authenticator 400 may correspond to sending session related information, e.g., Session ID, that can be received from the first I/O user device (IOD A) as part of the beacon signal.

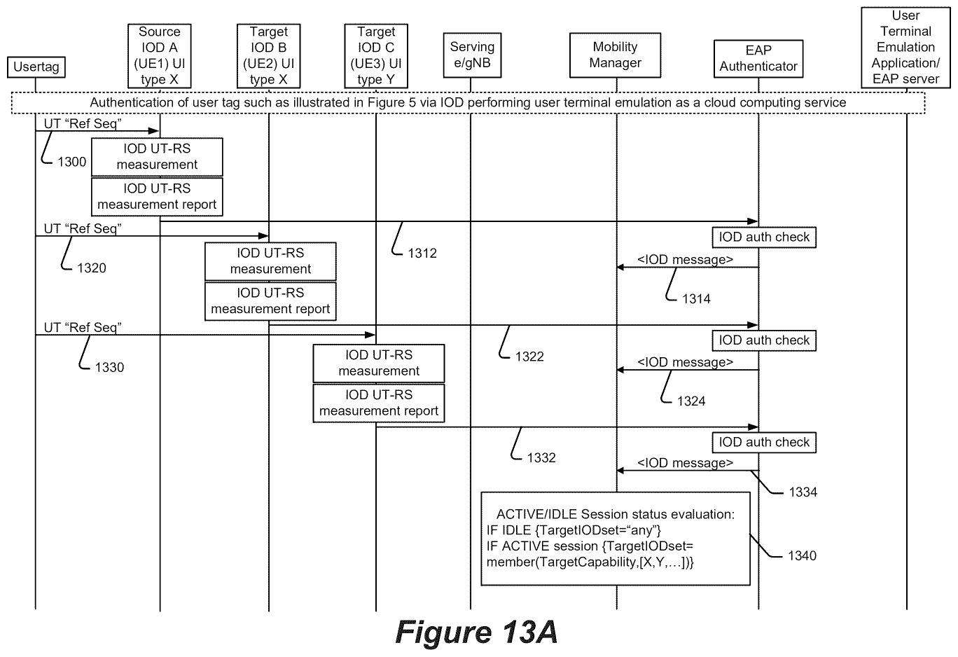

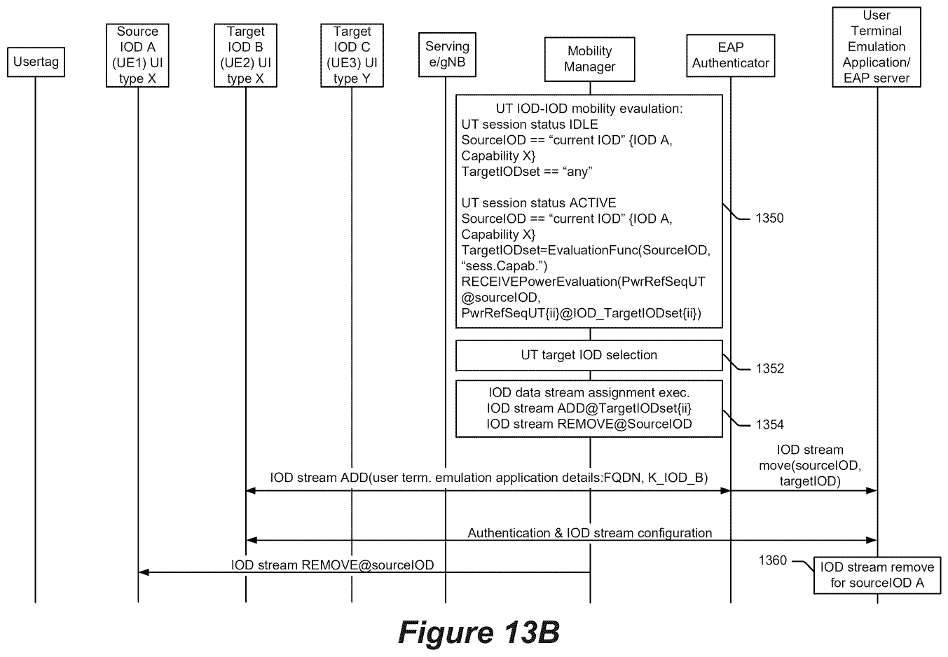

FIGS. 13A and 13B illustrate operations for mobility management of an active session in accordance with some embodiments of the present disclosure. FIG. 14 illustrates operations for mobility management during idle in accordance with some embodiments of the present disclosure. In FIGS. 13A, 13B, and 14 the description below, the term “IOD” refers to “I/O user device” for brevity. Although the illustrated embodiments are primarily directed to a scenario where the beacon signal measurement is routed from the IODs through the EAP authenticator to the mobile manager, in some other embodiments the beacon signal measurement is routed from the IODs to the mobility manager.

Referring to FIGS. 13A and 13B, the illustrated scenario provides mobility for an active user session where media content provided through the user terminal emulation application session (user terminal emulation application 110) is considered in the mobility evaluation to determine a valid target IOD (I/O user device 130). In this scenario the mobility evaluation can forego an IOD-set selection process before assessment of associated user tag Reference Sequence measurement reports provided from IODs detecting said signal is executed. FIG. 14 illustrates the idle scenario. Similar operations illustrated in FIGS. 13A, 13B, and 14 have been labeled with the same reference number.

Although not explicitly illustrated in FIGS. 13A and 13B, the IOD UI capability can be a composite capability provided by a composite IOD, such as a display screen connected to a camera, and a corresponding “IOD-set” may include UI separate or combined (composite) capabilities (e.g., camera, display screen, microphone, speakers, etc.) and also contain corresponding UI capability entries (e.g., camera-screen, microphone-speakers, camera-screen-speakers).

In the context of mobility management, the illustrated scenario of control plane functionality terminates in the user tag, and the user (data) plane terminates in any of the IODs.

In some embodiments, the control plane is terminated elsewhere than the user tag. In some embodiments, the user using an IOD to access a user terminal emulation application service (via a user terminal emulation application), can configure what IOD UI capability types are needed and then let the user terminal emulation application act on this configuration and request suitable IODs from the IODH 212 (user terminal emulation server 100). The IODH 212 or user terminal emulation server 100 orchestrates selecting (based on the defined UI capability requirements) suitable IODs for a session, select the IODs based on being proximately located to the user or otherwise at correct locations based on the beacon signal strength measurements, e.g., network/user terminal emulation application 110 controlled addition of IOD.

Referring to the active session scenario of FIGS. 13A and 13B, the user tag (“Usertag”) communicates through the IOD A to exchange information with the EAP authenticator and the user terminal emulation application to perform authentication operations such as described above with regard to FIG. 5. The operations may include the user tag sending a usertag attach request, receiving a user tag identity request, and providing a user tag identity response.

The “session beacon”: beacon can carry authenticated sessionID, e.g., sessionID.sequence@MAC, where MAC=base64 (HMAC (K, sessionID|sequence)). The beacon signal may be the plain session ID based “identity” as described above. Alternatively, the session ID based identity may be carried as identity in an EAP identity response message. This way, the beacon signal, when no association, broadcasts an EAP identity response message with the user tag actual identifier (ID), e.g. user@ user terminal emulation application, which can trigger the authentication to the user terminal emulation application via the IOD domain as described above. However, when there is an association and session available, the EAP identity response instead can carry the session ID based identity. The term K can be a shared secret known to the user tag and EAP Authenticator/IODH, e.g. PMK or key derived from PMK. Sequence is a wrapping sequence number, e.g. 32 bits long, where K could be re-generated when sequence wraps, and incremented for each broadcast.

The user tag transmits 1300 a user tag “Ref Seq” which corresponds to a beacon signal in accordance with various embodiments. IOD A receives and measures the beacon signal in operation “IOD UT-RS measurement”, and reports 1312 the beacon signal measurement in operation “IOD UT-RS measurement report” to the EAP authenticator. The EAP authenticator authenticates the beacon, e.g., based on the “third key” discussed above, and, when properly authenticated, relays 1314 the beacon and the accompanied beacon signal measurement to the mobility manager. The EAP authenticator may authenticate (verify) the beacon signal measurement based on, e.g., security set up and used between the EAP Authenticator and the IOD A. The beacon signal measurement may correspond to PwrRefSeqUT for a user tag “reference sequence” or “session beacon”, where “session beacon”: session related information, and where the beacon signal also carries an authenticated sessionID. Handling or the user tag beacon signal measurement procedures can include executing IOD user tag-RS measurement reporting, including PwrRefSeqUT for a UT “reference sequence” or “session beacon”. The EAP authenticator may authenticate the report of beacon signal measurement based on, e.g., infrastructure security such as long-lived security configuration in the IOD domain. Moreover, the EAP authenticator may authenticate or verify the beacon itself, such as based on the MAC as described above.

Similarly, the user tag continues to repetitively (e.g., periodically or nonperiodically) transmit 1320 the user tag “Ref Seq” which corresponds to a beacon signal in accordance with various embodiments. Alternatively, each of the IODs (IOD A, IOD B, and IOD C) may receive the same beacon signal, so that the operations described below with regard to FIG. 13A for IOD B are performed in parallel with those of IOD A and IOD C. IOD B receives and measures the beacon signal in operation “IOD UT-RS measurement”, and reports 1322 the beacon signal measurement in operation “IOD UT-RS measurement report” to the EAP authenticator. The EAP authenticator authenticates the beacon signal measurement and, when properly authenticated, relays 1324 the beacon signal measurement to the mobility manager. The beacon signal measurement may correspond to PwrRefSeqUT for a user tag “reference sequence” or “session beacon”, where “session beacon”: session related information, and where the beacon signal also carries an authenticated sessionID. Handling or the user tag beacon signal measurement procedures can include executing IOD user tag-RS measurement reporting, including PwrRefSeqUT for a UT “reference sequence” or “session beacon”.

Similarly, the user tag continues to repetitively (e.g., periodically or nonperiodically) transmit 1330 the user tag “Ref Seq” which corresponds to a beacon signal in accordance with various embodiments. Alternatively, as explained above, each of the IODs (IOD A, IOD B, and IOD C) may receive the same beacon signal. IOD C receives and measures the beacon signal in operation “IOD UT-RS measurement”, and reports 1332 the beacon signal measurement in operation “IOD UT-RS measurement report” to the EAP authenticator. The EAP authenticator authenticates the beacon signal measurement and, when properly authenticated, relays 1334 the beacon signal measurement to the mobility manager. The mobility manager receives the IOD UT-RS beacon signal measurement report, which may contain PwrRefSeqUT for a UT “reference sequence” or “session beacon”, and where “session beacon” can be session related information such as sessionID.

When the session status is active, the mobility manager can determine the new/next IOD (target IOD) and set 1340 the targetIODset to a member of the target UI capability (i.e., IOD A, IOD B, and/or IOD C). The mobility manager can send a message IOD stream ADD to a selected one or more of the IODs (e.g., IOD A, IOD B, and/or IOD C) where a stream is being switched to, and where the ADD message may include user terminal emulation application details: FQDN, K_IOD_<this_IOD>, stream ID. The message sent directly or indirectly to the IOD(s) being added may include information identifying the old/source IOD to enable use of distributed media stream routing schemes. The mobility manager can also send a message IOD stream REMOVE to one or more present IODs which were being used to receive or generate a stream for the active session, and which triggers the one or more present IODs to stop receiving or sending the stream and be removed from the session.

The user terminal emulation application can be provided with the IOD stream move information, such as the source IOD target IOD, and associated authentication and IOD stream configuration for the new or next IOD.

For active user sessions, the mobility management evaluations 1350 can be executed within a set of (e.g., directed toward) IODs with currently in-use capabilities (also called TargetIODset). The operations can determine SourceIOD UI capabilities, and determine the TargetIODset based on matching the function of SourceIOD capability and TargetIOD capabilities for potential TargetIOD provided IOD UT-RS measurement report, and selecting the TargetIODset out of IOD@ (capability==SourceIOD capability). For evaluation of user tag IOD to IOD mobility (UT IOD_IOD), the operations can consider ReceivePowerEvaluation (PwrRefSeqUT@sourceIOD, PwrRefSeqUT{ii}@IOD_TargetIODset{ii}). The term PwrRefSeqUT{ii}@IOD_TargetIODset{ii} corresponds to IOD UT-RS beacon signal measurement reports. The beacon signal measurement report values can be filtered, as will be described in further detail below. The mobility evaluation can be performed based on ReceivePowerEvaluation (PwrRefSeqUT@sourceIOD, PwrRefSeqUT{ii}@IOD_TargetIODset{ii}) corresponds to respective enter/exit criterions.

The UT IOD-IOD mobility event can be triggered when: M_UT_IOD_target+Offset_target_IOD-Hyst>M_UT_IOD_source+Offset_source_IOD+Offset.

The UT IOD-IOD mobility event can be cancelled when: M_UT_IOD_target+Offset_target_IOD+Hyst<M_UT_IOD_source+Offset_source_IOD+Offset.

The target IOD for the user tag can be selected 1350 and 1352 according to obtained TargetIOD out of TargetIODset. A message can be generated 1354 for “IOD stream ADD” for the determined (selected) next IOD (TargetIOD). and a corresponding other message for “IOD stream REMOVE” can be generated for the determined (selected) previous IOD (SourceIOD). The IOD data stream routing and termination operations can include sending the IOD stream ADD message directly or indirectly to the next IOD (e.g., IOD B) and the IOD stream REMOVE message can be sent to the previous (old) IOD (e.g., IOD A). The user terminal emulation application/EAP server can operate to remove 1360 the IOD stream for the sourceIOD A.

In FIGS. 13B and 14, the mobility manager operates to ADD the Target IOD, e.g., via the step to generate 1354 and 1400 the message for “IOD stream ADD” for the determined (selected) next IOD (TargetIOD). Alternatively, the operations for adding the Target IOD (e.g., IOD B) may include the mobility manager notifying the EAP authenticator to add the Target IOD to an identified stream. The EAP authenticator can provide the add information to the Target IOD. For example, in the example context of FIG. 5, the EAP authenticator 400 can receive the notification message from the mobility manager (FIG. 13A) corresponding to step 514A in FIG. 5 and operate to send an IOD stream ADD message to the Target IOD (e.g., IOD B). The mobility manage may still send the IOD stream REMOVE message to the previous old IOD (e.g., IOD A).

Although FIGS. 13A and 13B are primarily directed to the active session scenario, when the session status is idle the mobility manager can set 1340 the TargetIODset to “any.” For IDLE user sessions, IOD mobility evaluations may be executed similarly, but within the set of any IOD detected in via IOD UT-RS measurement report and approved validity of by EAP Authenticator. Thus, operations for UI capability matching for the service are not necessary. In operation 1400, the mobility manager can add the target IOD to the set (Target IOD ADD) and can remove the source IOD from the set (Source IOD REMOVE).

Operations by the EAP authenticator can include to derive the key to be used for protecting identity carried in the user tag beacon signal, e.g., key used in HMAC. This could be based on PMK. EAP Authenticator can be utilized in 2 different ways, depending on how the beacon is carried.

According to the first way, if the beacon signal just carries the plain session ID based identity, the EAP authenticator is not involved in mobility events, other than for generating user tag specific keys. However, the EAP Authenticator derives the key to be used for beacon HMAC and provides it to IODH so that IODH can verify the beacon signals.

According to the second way, if the beacon signal carries the session ID and other data as identifier in an EAP Identity response message, IODs can either forward the beacon/identity response to the EAP Authenticator or to the mobility manager (e.g., IODH). If forwarded to the mobility manager (e.g., IODH), the EAP authenticator does not play any further role than in the case when the beacon signal is just the plain session ID based identity. Thus, the rest of the description for EAP Authenticator is for the scenario where beacon carries and EAP Identity response message, which is by the IODs forwarded to the EAP Authenticator.

The EAP authenticator communicates with the mobility manager (e.g., IODH), and provides the verified beacon (e.g., verifies MAC etc. of session ID based identifier carried by EAP message), together with IOD reported signal strength, to the mobility manager (e.g., IODH) so that the mobility manager (e.g., IODH) can use the information to make mobility management decisions etc. When the beacon signal is just a plain session ID based beacon, the EAP authenticator generates IOD specific keys upon request from IODH and provides the key and other relevant info to the target IOD (directly or via IODH).

The EAP authenticator can optionally forward communication between the mobility manager (e.g., IODH) and the user terminal emulation server.

The IODH or mobility manager receives beacon reports from IODs, including beacon and signal strength etc. The EAP authenticator sends IOD specific key, user terminal emulation application FQDN, session ID and information about which stream the (target) IOD should request from the user terminal emulation application, e.g., which identifies stream currently being sent to the source IOD. This may be sent directly by the EAP authenticator or via the mobility manager (e.g., IODH).

The EAP authenticator verifies the received beacon identifier authenticity by verifying MAC, derives keys for IODs based on PMK and IOD identifier (as provided by IODH or mobility manager), and updates user tag beacon signal protection key when sequence number wraps based on a KDF known to the user tag (UT) and EAP Authenticator.

The user terminal emulation application/EAP server, communicates directly or indirectly (e.g., via the EAP authenticator) with the mobility manager (e.g., IODH) to optionally receive IOD stream move information (e.g., source IOD, target IOD). The user terminal emulation application/EAP server also communicates with the IODs. The target IOD authenticates to user terminal emulation server and indicates the stream currently being sent to source IOD that should be moved to target IOD. The user terminal emulation server may verify this with information optionally received from the mobility manager (e.g., IODH). The user terminal emulation application/EAP server performs re-routing of the stream from the source IOD to the target IOD.

Some further embodiments are directed to operations for performing IOD-to-IOD mobility evaluation based on user tag beacon signal strength measurements.

An IOD or the mobility manager/IODH may apply filtering to the beacon signal strength measurement data before the data is used to evaluate if any mobility-triggering events has occurred at the usertag-layer (e.g., has a handover or other mobility rule been satisfied).

Filtering may be based legacy 3GPP L3 filtering procedures, the filtering is performed by either the IOD or the mobility manager/IODH instead of by a e/gNB according to 3GPP L3 filtering procedures.

In some embodiments, the filtering function is based on the following equation:

$$Fn = ( 1 - a ) * Fn - 1 + ( a * MEASn ) ,$$

where Fn=updated filtered measurement result,
Fn−1=previous filtered measurement result,
a=(1/2)^{k/4}, with k as filter coefficient, selected by mobility manager/IODH, and
MEASn=latest measurement result received from UT via source/target IODs.

The latest measurement result, MEASn, may be based on {M_UT_IOD_target, M_UT_IOD_source}.

Depending on architectural choice, it can be advantageous for filtering to be performed by the mobility manager/IODH.

In some applications with capable IODs and where filtering is based on parameters obtained from the mobility manager/IODH, IODs may adopt the filtering and, e.g., make use of relaxed/hysteresis-based less frequent IOD-measurement reporting to the mobility manager/IODH.

A user tag IOD-IOD mobility event can be configured to be triggered when a IOD beacon signal measurement report (from a first IOD) becomes better than another IOD beacon signal measurement report (from a second IOD) by a predefined offset value during a preset period of time (Time to Trigger, TTT). The offset value may either positive or negative, and offset values and TTT may be defined per individual IOD. In some embodiments, the user tag IOD-IOD mobility event is triggered when:

$$M\_UT \_IOD \_target + Offset\_target \_IOD - Hyst > M\_UT \_IOD \_source + Offset\_source \_IOD + Offset .$$

In some embodiments, the user tag IOD-IOD mobility event is cancelled when a user tag received beacon signal power detected at one (neighboring) IOD becomes worse than the user tag received beacon signal power detected at the current (source) IOD by an (IOD-specific is desired) offset during “time to trigger”. In some embodiments, the UT IOD-IOD mobility event is cancelled when:

$$M\_UT \_IOD \_target + Offset\_target \_IOD + Hyst < M\_UT \_IOD \_source + Offset\_source \_IOD + Offset ,$$

where:
M_UT_IOD_source: signal level or quality or UT received from source IOD to managing server;
M_UT_IOD_target: signal level or quality or UT received from target IOD to managing server;
Offset: UT IOD-IOD mobility is performed only when the signal of the UT at target IOD is significantly better than that of the UT received at the serving (source) IOD;
Offset_target_IOD: IOD-specific individual offset for the target IOD;
Offset_source_IOD: IOD-specific cell specific offset for the source IOD;
Time to Trigger: this timer helps to avoid irregular measurement and handover; and
Hyst: hysteresis, it is defined in managing node to avoid “ping-pong” with respect to mobility between two IODs.

Some other further embodiments are directed to handoff (handover) where the user tag is leaving the reception range of an IOD, resulting in the IOD being outside of beacon signal reception capability. The operations may use similar triggering decisions for handoff as was discussed above for IOD cell mobility, and which may include use of offsets and hysteresis such as described above. For example, handoff to a no-coverage situation is typically associated with other signal strength thresholds, etc. than with IOD-to-other-IOD mobility, such as due to the impact of the user completely losing coverage compared to “perceiving somewhat poor quality for some period of time” is more severe.

### Cloud Implementation

Some or all operations described above as being performed by the I/O user devices, the mobility manager, the authenticator, the user terminal emulation server, the EAP authenticator, the AKMA system or server may alternatively be performed by another node that is part of a cloud computing resource. For example, those operations can be performed as a network function that is close to the edge, such as in a cloud server or a cloud resource of a telecommunications network operator, e.g., in a CloudRAN or a core network, and/or may be performed by a cloud server or a cloud resource of a media provider, e.g., iTunes service provider or Spotify service provider.

Abbreviations:

| | |
|---|---|
| 3GPP | 3^{rd} Generation Partnership Project′ |
| App | Application, i.e. program |
| BS | Base station, e.g., e/gNB |
| BT | Bluetooth |
| DL | Downlink |
| EAP | Extensible Authentication Protocol |
| e/gNB | Evolved Node B, Next Generation Node B |
| eNB | Evolved Node B (a.k.a. RBS, Radio Base Station) |
| FQDN | Fully Qualified Domain Name |
| GW | Gateway (also. acronym for Leif GW Persson) |
| HO | Handover |
| ICMP | Internet Control Message Protocol |
| IOD | Input and/or Output Device |
| ITU | International Telecommunication Union |
| KDP | Key Derivation Function |
| MIMO | Multiple Input Multiple Output |
| NFC | Near Field Communication |
| RFID | Radio Frequency Identification |
| RSRP | Reference Symbol Received Power |
| RTP | Real Time Protocol |
| RTCP | Real Time Control Protocol |
| IOD | Input Output Device |
| IODH | Input Output Device Handler |
| NTP | Network Time Protocol |
| S1 | Interface in 3GPP LTE |
| SDP | Session Description Protocol |
| SR | Sender Response |
| SRS | Sounding Reference Symbol (or Signal) |
| TTT | Time To Trigger |
| UE | User equipment |
| UL | Uplink |
| X2 | Interface in 3GPP, between eNBs in LTE |

### Further Definitions and Embodiments

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

1. A user tag which is transportable by a user and comprising circuitry configured to:
perform an authentication process with an authenticator via communications through an input and/or output, I/O, user device to obtain session related information; and
transmit a beacon signal containing the session related information to I/O user devices proximately located to the user tag.

2. The user tag of claim 1, wherein the circuitry is further configured to:
obtain the session related information based on an authenticated session identifier obtained through communications with the authenticator for authentication.

3. The user tag of claim 1, wherein the circuitry is further configured to:
obtain the session related information from an Extensible Authentication Protocol, EAP, response message from the authenticator.

4. The user tag of claim 1, wherein the circuitry is further configured to:
receive beacon configuration information from the I/O user device; and
transmit the beacon signal an interval defined based on the beacon configuration information.

5. The user tag of claim 1, wherein the circuitry is further configured to:
receive beacon configuration information from the I/O user device; and
transmit the beacon signal at a power level defined based on the beacon configuration information.

6. The user tag of claim 1, wherein the circuitry is further configured to:
derive a key based on the authentication process with the authenticator; and
transmit the beacon signal with secure communications protection using the key.

7. An input and/or output, I/O, user device comprising circuitry configured to:
receive a beacon signal from a user tag transportable by a user, the beacon signal containing session related information; and
measure signal strength of the beacon signal to generate a beacon signal measurement; and
send the beacon signal measurement and the session related information for use by a mobility manager for mobility management of a communication service for the user that can be provided by a user terminal emulation server through one or more I/O user devices.

8. The I/O user device of claim 7, wherein the circuitry is further configured to:
receive from the mobility manager a message containing an instruction to add an I/O traffic stream associated with the session related information; and
initiate outputting and/or inputting through at least one I/O user interface of the I/O user device content of the I/O traffic stream associated with the session related information between the I/O user device and a user terminal emulation application.

9. The I/O user device of claim 7, wherein the circuitry is further configured to:
receive from the mobility manager a message containing an instruction to remove an I/O traffic stream associated with the session related information; and
cease outputting and/or inputting through at least one I/O user interface of the I/O user device content of the I/O traffic stream associated with the session related information between the I/O user device and a user terminal emulation application.

10. The I/O user device of claim 7, wherein the circuitry is further configured to:
generate the beacon signal measurement based on a present measurement of signal strength of the beacon signal presently received from the user tag combined with at least one previous measurement of signal strength of at least one previously received beacon signal from the user tag.

11. The I/O user device of claim 10, wherein to send the beacon signal measurement and the session related information to the mobility manager for mobility management of the communication service for the user, the circuitry is further configured to:
send the beacon signal measurement for use by the mobility manager at a periodic interval of length to receive a plurality of beacon signals from the user tag for use in generating the beacon signal measurement based on combining the measurements of signal strength of the plurality of beacon signals.

12. The I/O user device of claim 7, wherein the circuitry is further configured to:
trigger sending of the beacon signal measurement for use by the mobility manager responsive to at least a threshold change in measurements of signal strength over a sequence of received beacon signals.

13. A mobility manager for managing mobility of a communication service for a user through input and/or output, I/O, user devices, the mobility manager comprising circuitry configured to:
receive from a plurality of I/O user devices, a beacon signal measurement and session related information, the beacon signal measurement indicating a signal strength measurement by the I/O user device of a beacon signal from a user tag transportable by the user; and
initiate mobility switching of an I/O traffic stream associated with the session related information from being routed between a user terminal emulation application hosted by a user terminal emulation server and a first I/O user device to being routed between the user terminal emulation application and a second I/O user device, responsive to determining a mobility switching rule is satisfied based on comparison of the beacon signal measurements by the first I/O user device and the second I/O user device.

14. The mobility manager of claim 13, wherein the circuitry is further configured to:
determine the mobility switching rule is satisfied for switching the I/O traffic stream to the second I/O user device based on determining a user interface, UI, capability of the second I/O user device is operational for providing the communication service, and based on the comparison of the beacon signal measurements by the first I/O user device and the second I/O user device.

15. The mobility manager of claim 14, wherein the circuitry is further configured to:
further determine the mobility switching rule is satisfied for switching the I/O traffic stream to the second I/O user device based on measurements of radio channel quality between a radio access network and the first and second I/O user devices and/or based on measurements of link status of the first and second I/O user devices.

16. The mobility manager of claim 14, wherein the circuitry is further configured to:
determine the mobility switching rule is satisfied for switching the I/O traffic stream to the second I/O user device based on determining the UI capability of the second I/O user device is combinable with a UI capability of a third I/O user device to satisfy a combined UI capability operational required for providing the communication service, and based on the beacon signal measurements by the first I/O user device, the second I/O user device, and the third I/O user device.

17. The mobility manager of claim 13, wherein the circuitry is further configured to:
determine the mobility switching rule is satisfied for switching the I/O traffic stream to the second I/O user device based on determining that a result of summation of the beacon signal measurement by the second I/O user device and a second offset threshold exceeds a result of summation of the beacon signal measurement by the first I/O user device and a first offset threshold.

18. The mobility manager of claim 13, wherein the circuitry is further configured to:
based on determining the beacon signal measurement by a third I/O user device satisfies a database addition rule, updating a database to add the beacon signal measurement and the session related information of the third I/O user device to be associated with an indication of a user interface, UI, capability of the third I/O user device, wherein the database identifies network addresses of I/O user devices and UI capabilities of the I/O user devices that are candidates for use in providing the communication service to the user.

19. The mobility manager of claim 13, wherein to initiate mobility switching of the I/O traffic stream from being routed between the user terminal emulation application and the first I/O user device to being routed between the user terminal emulation application and the second I/O user device, the circuitry is further configured to:
send to the second I/O user device a message containing an instruction to add the I/O traffic stream associated with the session related information; and
send to the first I/O user device a message containing an instruction to remove the I/O traffic stream associated with the session related information.

20.-22. (canceled)

23. An authenticator comprising circuitry configured to:
establish a key through an authentication process with a user tag via a first input and/or output, I/O, user device;
authenticate a beacon signal from the first I/O user device based on the key, the beacon being accompanied by a beacon signal measurement indicating a signal strength measurement by the first I/O user device of the beacon signal from a user tag transportable by the user; and
responsive to authentication of the beacon signal, send the beacon signal and the beacon signal measurement to a mobility manager managing mobility of a communication service for a user through I/O user devices.
